(19) United States
(12) Patent Application Publication
(10) Pub. No.: US 2026/0269374 A1
(43) Pub. Date: Sep. 10, 2026

(54) HIGH TEMPERATURE GEL PROCESSED INSULATION COMPOSITE AND ARTICLES MADE THEREFROM

(71) Applicant: W. L. Gore & Associates, Inc., Newark, DE (US)

(72) Inventors: Kelly Hillen, Chestertown, MD (US); David DeGennaro, Newark, DE (US)

(21) Appl. No.: 19/557,660

(22) Filed: Mar. 5, 2026

Related U.S. Application Data
(60) Provisional application No. 63/768,701, filed on Mar. 7, 2025.

(51) Int. Cl. H01M 10/658; B32B 5/18; B32B 7/05; B32B 27/06; B32B 27/20; H01M 10/0525

(52) U.S. Cl. CPC H01M 10/658; B32B 5/18; B32B 7/05; B32B 27/065; B32B 27/20; B32B 2250/03; B32B 2250/04; B32B 2250/05; B32B 2264/10; B32B 2266/0278; B32B 2305/022; B32B 2305/30; B32B 2307/304; B32B 2307/7376; B32B 2457/10; H01M 10/0525

(57) ABSTRACT

Multilayer high-temperature insulative composites that include a gel processed polymer matrix, insulative particles, and additional components are disclosed. In some embodiments, the multilayer high-temperature insulative composite includes at least one insulative composite layer including less than 35 wt % of a gel processed polymer matrix, more than 40 wt % insulative particles, and less than 35 wt % other materials bonded to a second layer to define a diffused bonded portion of the multilayer insulative composite, wherein the diffused bonded portion is defined by an ultrasonic bond. The additional materials include, but are not limited to, an opacifier, an antioxidant, reinforcement fiber(s), and combinations thereof.

### CROSS-REFERENCE TO RELATED APPLICATION

This application claims the benefit of Provisional Application No. 63/768,701, filed Mar. 7, 2025, which is incorporated herein by reference in its entirety for all purposes.

### FIELD

The present disclosure relates generally to gel processed thermally insulative materials, and more specifically, to flexible, thin high temperature insulation composites and articles made therefrom that have excellent mechanical properties and are able to maintain insulative and thermal barrier properties when exposed to high temperatures.

### BACKGROUND

Certain applications, such as battery cell packs, may benefit from using high temperature insulative materials that can also function as a high temperature insulative composite capable of withstanding very high temperatures, such as a thermal runaway event in a lithium-ion battery. However, many conventional insulative materials are difficult to handle, are difficult to form into a desired shape or thickness suitable for the intended application, and/or they may suffer from excessive dusting.

Various protective articles require insulative materials that are thin, strong, compressible, and have insulative properties (e.g., a thermal conductivity sufficient for the intended use). However, some insulative materials are used in applications or devices where a high temperature event may occur, such as when a component within the device malfunctions and releases an amount of energy sufficient to trigger an adverse event (e.g., a thermal runaway event). The resulting temperature increase could potentially damage other components within or external to the device. In some embodiments, a high temperature event may be sufficient to damage a second component, wherein damage to the second component may trigger a second high temperature event (for example, adjacent cells within a high energy battery (e.g., a lithium-ion battery).

In addition, thermal insulation materials, such as those used in battery modules and packs for electric vehicles (EVs) and battery energy storage systems (BESS) require lamination to achieve the final product form. This may include laminating two or more layers of insulation material together to obtain a thicker article. Alternatively, or in addition, this may include bonding the insulation to a different material.

Common methods for laminating include adhesives, which are expensive and negatively impact thermal performance, including conductivity and flame resistance. Moreover, insulative materials such as aerogel-based materials with ePTFE or glass fiber scrim suffer from high particulation (e.g., dusty), low z-strength, and lack of a suitable, spatially uniform thermoplastic scaffold. Accordingly, they cannot be laminated without additional polymeric layers (e.g., encapsulation films, adhesives).

Thus, there remains a need for a high temperature insulative composite that is suitable for use in high temperature applications as well as a better method to bond two or more layers of insulation material together or to a different material.

### SUMMARY

According to one aspect, (“Aspect 1”), a multilayer insulative composite comprises an insulative composite layer comprising greater than about 50 wt % of insulative particles, less than about 35 wt % of a gel processed polymer matrix, and less than about 35 wt % of a combined total of additional components, based on the total weight of the insulative composite layer; and a second layer bonded to the insulative composite layer to define a diffused bonded portion of the multilayer insulative composite; wherein the diffused bonded portion is defined by an ultrasonic bond; wherein the insulative composite layer has a compressibility less than about 35% at 1 MPa.

Aspect 2 is the multilayer insulative composite of Aspect 1, wherein the second layer includes a second insulative composite layer comprising greater than about 50 wt % of insulative particles, less than about 35 wt % of a gel processed polymer matrix, and less than about 35 wt % of a combined total of additional components based on the total weight of the second insulative composite layer.

Aspect 3 is the multilayer insulative composite of Aspect 1, wherein the second layer includes a compressible foam layer or a porous layer.

Aspect 4 is the multilayer insulative composite of Aspect 3, wherein the compressible foam layer comprises a polyurethane foam.

Aspect 5 is the multilayer insulative composite of any one of the preceding Aspects, wherein the diffused bonded portion includes an edge bond along an outer perimeter of the insulative composite layer.

Aspect 6 is the multilayer insulative composite of Aspect 5, wherein the edge bond includes one or more edge bond portions adjacent to the outer perimeter, on the outer perimeter, or both adjacent to and on the outer perimeter of the insulative composite layer.

Aspect 7 is the multilayer insulative composite of Aspects 5 or 6, wherein the edge bond is defined along the outer perimeter and spans from 10% to 100% of a total length of the outer perimeter of the insulative composite layer.

Aspect 8 is the multilayer insulative composite of any one of Aspects 5 to 7, wherein the edge bond is defined by a plurality of discontinuous edge bond portions along the outer perimeter.

Aspect 9 is the multilayer insulative composite of any one of Aspects 5 to 7, wherein the edge bond is defined by a continuous bond along the outer perimeter.

Aspect 10 is the multilayer insulative composite of any one of the preceding Aspects, wherein the diffused bonded portion includes one or more interior bond portions defined within the outer perimeter of the multilayer insulative composite between opposing faces of the insulative composite layer and the second layer.

Aspect 11 is the multilayer insulative composite of Aspect 10, wherein the interior bond portions are defined over from 0.1% to 20% of a surface area of the opposing faces of the insulative composite layer and the second layer.

Aspect 12 is the multilayer insulative composite of Aspects 10 or 11, wherein the interior bond portions are arranged in a pattern across the opposing faces of the insulative composite layer and the second layer.

Aspect 13 is the multilayer insulative composite of Aspect 12, wherein the pattern includes either a regular, repeating pattern or a random pattern.

Aspect 14 is the multilayer insulative composite of any one of Aspects 10 to 13, wherein the interior bond portions are characterized by a shape, and further wherein the shape includes a square, rounded, rectangular, linear, irregular, or polygonal shape.

Aspect 15 is the multilayer insulative composite of any one of the preceding Aspects, characterized by an absence of any adhesive between the insulative composite layer and the second layer.

Aspect 16 is the multilayer insulative composite of any one of the preceding Aspects, wherein the insulative composite layer has a thickness of from about 0.1 mm to about 2 mm.

Aspect 17 is the multilayer insulative composite of Aspect 16, wherein the insulative composite layer has a thickness of from about 0.5 mm to about 1.5 mm.

Aspect 18 is the multilayer insulative composite of Aspect 16, wherein the multilayer insulative composite comprises more than two insulative composite layers.

Aspect 19 is the multilayer insulative composite of Aspect 18, wherein the multilayer insulative composite includes from 3 to 10 insulative composite layers bonded to each adjacent layer using ultrasonic bonding.

Aspect 20 is the multilayer insulative composite of Aspect 18, wherein the multilayer insulative composite has a total thickness of from about 0.2 mm to about 20 mm.

Aspect 21 is the multilayer insulative composite of any one of the preceding Aspects, wherein the insulative composite layer defines a geometric shape comprising a rectangle, a circle, a triangle, a square, an oval, or a polygon.

Aspect 22 is an article comprising the multilayer insulative composite of any one of Aspects 1-21.

Aspect 23 is use of the multilayer insulative composite of any one of Aspects 1 to 21 to prevent thermal propagation within a lithium-ion battery.

Aspect 24 is the multilayer insulative composite of any one of Aspects 1 to 21, wherein the insulative particles are selected from fumed silica, amorphous silica, colloidal silica, precipitated silica, fused silica, silica gel, silica xerogel, aerogels, silica aerogels, silicates, fumed metal oxides, and combinations thereof.

Aspect 25 is the multilayer insulative composite of Aspect 24, wherein the insulative particles are fumed silica particles.

Aspect 26 is the multilayer insulative composite of any one of Aspects 1 to 25, wherein the insulative particles comprise greater than about 70 wt % of the insulative composite.

Aspect 27 is the multilayer insulative composite of any one of Aspects 1 to 26, wherein the gel processed polymer matrix comprises a gel processed polymer selected from polyethylene, polypropylene, ethylene-propylene copolymers, polyoxymethylene, polyethylene oxide, polyamides, polyethyleneterephtalate, polyacrylonitrile, polyvinylalcohol, polyhydroxyalkanoates (PHAs), polylactic acid (PLA), and polyvinylidenefluoride.

Aspect 28 is the multilayer insulative composite of Aspect 27, wherein the gel processed polymer matrix comprises a gel processed polyethylene (PE) having a number average molecular weight greater than about 500,000 g/mol.

Aspect 29 is the multilayer insulative composite of any one of Aspects 1 to 28, wherein the gel processed polymer matrix comprise less than about 20 wt % of the insulative composite.

Aspect 30 is the multilayer insulative composite of any one of Aspects 1 to 29, wherein the insulative composite is non-particulating.

Aspect 31 is the multilayer insulative composite of any one of the preceding Aspects, wherein a total of the additional components comprises one or more opacifier, one or more antioxidant, one or more reinforcement fiber, or any combination thereof.

Aspect 32 is the multilayer insulative composite of Aspect 31, wherein the opacifier is selected from carbon black, titanium dioxide, aluminum oxide, zirconium dioxide, iron oxides, silicon carbide, molybdenum silicide, manganese oxide, a polydialkylsiloxane where the alkyl groups contain 1 to 7 carbon atoms, or any combination thereof.

Aspect 33 is the multilayer insulative composite of any one of the preceding Aspects, wherein a total of the additional components comprises less than about 20 wt % of the insulative composite.

Aspect 34 is the multilayer insulative composite of any one of the preceding Aspects, wherein the gel processed polymer matrix comprises a blend of at least two different number average molecular weights of the gel processed polymer.

Aspect 35 is the multilayer insulative composite of any one of the preceding Aspects, wherein the insulative composite is in the form of an extruded profile, extruded article, injection molded shape, or injection molded article.

Aspect 36 is the multilayer insulative composite of any one of the preceding Aspects, wherein the insulative particles and additional components are present through a thickness thereof.

Aspect 37 is the multilayer insulative composite of any one of the preceding Aspects, wherein particulate components are present through a thickness thereof.

According to one aspect (“Aspect 38”), an article comprises a first component capable of a generating a high temperature event comprising a first temperature; a second component to be protected against exposure to the first temperature; and a multilayer insulative composite positioned between the first component and the second component, the multilayer insulative composite having a first side oriented toward the first component and an opposing side oriented towards the second component; wherein the multilayer insulative composite comprises: an insulative composite layer comprising greater than about 50 wt % of insulative particles, less than about 35 wt % of a gel processed polymer matrix, and less than about 35 wt % of a combined total of additional components, based on the total weight of the insulative composite layer; and a second layer bonded to the insulative composite layer to define a diffused bonded portion of the multilayer insulative composite; wherein the diffused bonded portion is defined by an ultrasonic bond; wherein the insulative composite layer has a compressibility less than about 35% at 1 MPa.

Aspect 39 is the article of Aspect 38, wherein the second layer includes a compressible foam layer or a porous layer.

Aspect 40 is the multilayer insulative composite of Aspect 38 or Aspect 39, wherein the gel processed polymer matrix comprises a gel processed polymer selected from polyethylene, polypropylene, ethylene-propylene copolymers, polyoxymethylene, polyethylene oxide, polyamides, polyethyleneterephtalate, polyacrylonitrile, polyvinylalcohol, polyhydroxyalkanoates (PHAs), polylactic acid (PLA), and polyvinylidenefluoride.

Aspect 41 is the insulative composite of any one of Aspects 38 to 40, wherein the gel processed polymer matrix comprises less than about 20 wt % of the insulative composite.

Aspect 42 is the article of any one of Aspects 38 to 41, wherein the gel processed polymer matrix comprises an expanded gel processed polyethylene (PE) having a number average molecular weight greater than 500,000 g/mol.

Aspect 43 is the article of any one of Aspects 38 to 42, wherein the gel processed polymer matrix comprises a blend of at least two different number average molecular weights of the gel processed polymer.

Aspect 44 is the article of any one of Aspects 38 to 43, wherein the insulative particles are selected from fumed silica, amorphous silica, colloidal silica, precipitated silica, fused silica, silica gel, silica xerogel, aerogels, silica aerogels, silicates, fumed metal oxides, and combinations thereof.

Aspect 45 is the article of any one of Aspects 38 to 44, wherein the insulative particles comprise greater than about 70 wt % of the insulative composite.

Aspect 46 is the article of any one of Aspects 38 to 45, wherein the additional components comprise one or more opacifier, one or more antioxidant, one or more reinforcement fiber or any combination thereof.

Aspect 47 is the multilayer insulative composite of any one of Aspects 38 to 46, wherein a total of the additional components comprises less than about 20 wt % of the insulative composite.

Aspect 48 is the article of any one of Aspects 38 to 47, wherein the article has a thickness less than about 25 mm.

Aspect 49 is the article of any one of the Aspects 38 to 48, wherein the article prevents thermal propagation in a lithium-ion battery.

Aspect 50 is the article of any one of the Aspects 38 to 49, comprising a support layer directly bonded to the insulative composite.

Aspect 51 is a method of using the article of any one of Aspects 38 to 50 to prevent thermal propagation within a lithium-ion battery.

According to one aspect (“Aspect 52”), a method comprises providing an insulative composite layers comprising greater than about 50 wt % of insulative particles, less than about 35 wt % of a gel processed polymer matrix, and less than about 35 wt % of a combined total of additional components, based on the total weight of the insulative composite layer; providing a second layer comprising a second insulative composite layer or a compressible foam layer; and applying ultrasonic energy to an edge or a surface of the insulative composite layer and the second layer to bond the insulative composite layer to the second layer; wherein the insulative composite layer has a compressibility less than about 35% at 1 MPa.

According to one aspect (“Aspect 53”), a lithium-ion battery comprises: a first battery cell capable of a generating a high temperature event comprising a first temperature; a second battery cell to be protected against exposure to the first temperature; and a multilayer insulative composite positioned between the first battery cell and the second battery cell, the multilayer insulative composite having a first side oriented toward the first battery cell and an opposing side oriented towards the battery cell; wherein the multilayer insulative composite comprises: an insulative composite layer comprising greater than about 50 wt % of insulative particles, less than about 35 wt % of a gel processed polymer matrix, and less than about 35 wt % of a combined total of additional components, based on the total weight of the insulative composite layer; and a second layer bonded to the insulative composite layer to define a diffused bonded portion of the multilayer insulative composite; wherein the diffused bonded portion is defined by an ultrasonic bond; wherein the insulative composite layer has a compressibility less than about 35% at 1 MPa.

Aspect 54 is the multilayer insulative composite of any one of the preceding Aspects, wherein the insulative composite layer has an average maximum temperature less than about 250° C. as determined using a protective heat propagation barrier assay at about 1 mm thickness.

Aspect 55 is the multilayer insulative composite of any one of the preceding Aspects, wherein the insulative composite layer has a Z-strength greater than about 25 N.

Aspect 56 is the multilayer insulative composite of any one of the preceding Aspects, wherein the diffused bonded portion comprises an interdiffused bonded portion.

Aspect 57 is the multilayer insulative composite of any one of the preceding Aspects, wherein the diffused bonded portion has a higher density than a density of the insulative composite layer; wherein the diffused bonded portion has a higher density than a density of the second layer.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1A is a schematic cross-section of a high temperature insulative composite having therein varying particulate components through a thickness thereof in accordance with some embodiments;

FIG. 1B is a schematic cross-section of a multi-layer high temperature insulative composite having therein differing particulate size distributions in different layers in accordance with some embodiments;

FIG. 2 is a schematic illustration of the testing system used to evaluate the performance of samples in the Protective Heat Propagation Barrier Testing in accordance with some embodiments;

FIG. 3 is a graphical illustration of a representative plot of the heat accumulator temperature and the temperature measured on the opposing sides of the composite insulation sample over test duration in accordance with some embodiments;

FIG. 4 is a scanning electron micrograph (SEM) of a cross-section of a gel processed insulative composite showing opacifier particles distributed throughout the gel processed insulative composite in accordance with some embodiments;

FIG. 5 is a blown-up view of the scanning electron micrograph (SEM) of FIG. 4 in accordance with some embodiments;

FIG. 6 is a graphical illustration of the compressibility of the gel processed insulative composite of Example 1 and the non-gel processed insulative composite of Comparative Example 1;

FIG. 7A is a schematic top view and cross-sectional view of a multilayer insulative composite in accordance with some embodiments;

FIG. 7B is a schematic top view and cross-sectional view of a multilayer insulative composite in accordance with some embodiments;

FIG. 7C is a schematic top view and cross-sectional view of a multilayer insulative composite in accordance with some embodiments;

FIG. 7D is a schematic top view of a multilayer insulative composite in accordance with some embodiments;

FIG. 7E is a schematic top view of a multilayer insulative composite in accordance with some embodiments;

FIG. 7F is a schematic top view of a multilayer insulative composite in accordance with some embodiments.

### DETAILED DESCRIPTION

This disclosure is not meant to be read in a restrictive manner. For example, the terminology used in the application should be read broadly in the context of the meaning those in the field would attribute such terminology. Persons skilled in the art will readily appreciate that various aspects of the present disclosure can be realized by any number of methods and apparatus configured to perform the intended functions. It should also be noted that the accompanying figures referred to herein are not necessarily drawn to scale and may be exaggerated to illustrate various aspects of the present disclosure, and in that regard, the figures should not be construed as limiting.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. In the event it is determined that individuals having ordinary skill in the relevant arts would not readily ascertain values for such reasonably small differences, the terms “about” and “approximately” can be understood to mean plus or minus 10% of the stated value.

It is to be understood that the terms “high temperature insulative composite”, “insulative composite”, and “high temperature gel processed insulative composite” may be used interchangeably herein. In addition, the terms “thermally insulative particles” and “insulative particles” may be interchangeably used herein. Further, the terms “other components” and “additional components” may be interchangeably used herein.

### Definitions

As used herein, the singular forms “a”, “an”, and “the” include plural reference unless the context clearly dictates otherwise.

The term “on” as used herein is meant to denote that when an element is “on” another element, it can be directly on the other element or intervening elements may also be present.

The term “high temperature gel processed insulative composite” refers to an insulative composite that includes a gel processed polymer matrix and which functions as a protective heat propagation barrier when subjected to a transient temperature above 300° C.

As used herein, “gel processed polymer matrix” refers to a polymer having been formed by a gel process and specifically excludes any polymer formed by paste processing. In one embodiment, the gel process polymer matrix refers to gel processed polymer matrix formed from a polymer selected from polyethylene, ultra-high molecular weight polyethylene (UHMWPE), polypropylene, ethylene-propylene copolymers, polyoxymethylene, polyethylene oxide, polyamides, polyethyleneterephtalate, polyacrylonitrile, polyvinylalcohol, polyhydroxyalkanoates (PHAs), polylactic acid (PLA), and polyvinylidenefluoride. In another embodiment, the gel processed polymer matrix refers to a gel processed polymer matrix formed form gel processed polyethylene. In a further embodiment, the gel processed polymer matrix refers to a gel processed polymer matrix formed from gel processed UHMWPE.

The term “gel processed polyethylene” refers to an ultra-high molecular weight polyethylene (UHMWPE) formed by a gel process, and which has a number average molecular weight of at least about 200,000 g/mol, at least about 500,000 g/mol, at least about 1,000,000 g/mol, at least about 5,000,000 g/mol, at least about 7,000,000, or at least about 10,000,000 g/mol.

The terms “weight percent” or “wt %” are meant to denote the weight percent of that component based on the total weight percent of the final high temperature insulative composite (i.e., after diluent is removed). “Wt %” may be defined as the mass of the component divided by the total mass of the high temperature gel processed insulative component (after diluent is removed) multiplied by 100.

As used herein, the term “high temperature event” is intended to describe a situation where a temperature is generated sufficient to at least partially or fully decompose the polymeric material within the gel processed polymer matrix. In one aspect, the high temperature event is an event where a temperature of at least about 500° C. is achieved. In a further aspect, the high temperature event is an event where a temperature of at least 500° C. to about 1200° C. is achieved.

As used herein, “additional components” include opacifier(s), antioxidant(s), reinforcement fiber(s), and/or other particulate or non-particulate components, and combinations thereof.

The term “average maximum temperature” is meant to denote the temperature on the protected side in accordance with the Protective Heat Propagation Barrier Testing Assay described herein.

The term “non-particulating” as used herein is intended to describe the lack of particulate and/or non-particulate components (e.g., material) shedding or otherwise falling off the insulative composite during assembly or in use.

As used herein, the term “diffused bonded portion” is used to describe a bonded portion between two or more layers of materials, where at least one of the layers includes a polymer diffused across the interface of at least two of the layers, thus bonding the layers together at the bonded portion.

As used herein, the term “interdiffused bonded portion” is used to describe a bonded portion between two or more layers of materials, where at least two of the layers each includes a polymer diffused across the interface of the at least two layers, thus bonding the layers together at the bonded portion. In some embodiments, a first layer includes a first polymer, and a second layer includes a second polymer miscible with the first polymer.

### High Temperature Gel Processed Insulative Composites

The high temperature gel processed insulative composites of the present disclosure include a gel processed polymer matrix, insulative particles, and additional components (e.g., one or more opacifier, one or more antioxidant, reinforcement fiber(s), and/or other particulate or non-particulate components, as well as combinations thereof). In some embodiments, the high temperature insulative composite includes less than 35 wt % of a gel processed polymer matrix, more than 40 wt % insulative particles, and less than 35 wt % additional components. As set forth above, the term weight percent (wt %) is the percent of the total weight of the high temperature gel processed insulative composite. It is to be appreciated that the total wt % of all of the components that form the gel processed insulative composite equals 100 wt %. Additionally, the high temperature gel processed insulative composite may be formed into thin, flexible shapes, thereby facilitating the ability to fabricate shaped materials suitable for a target application. In some embodiments, the gel processed insulative composite is in the form of an extruded profile, extruded article, injection molded shape, or injection molded article. The gel processed insulative composite functions as a protective heat propagation barrier when subjected to a transient temperature above 300° C.

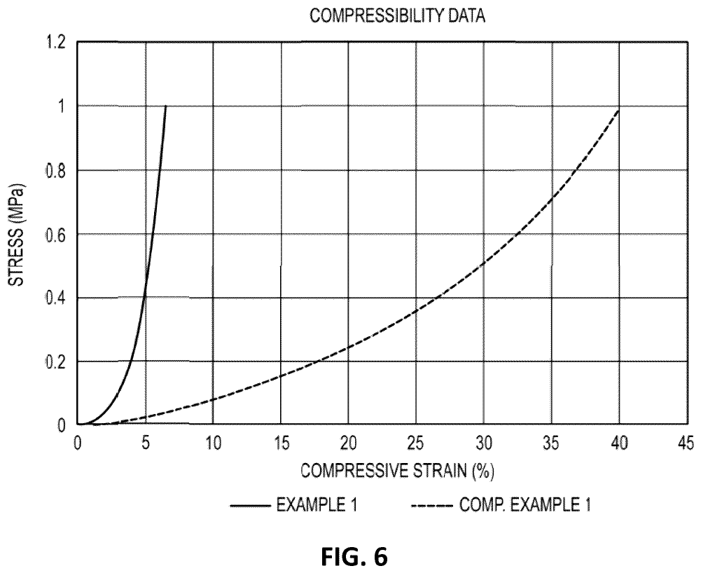

The insulative composite is suitable for use in lithium-ion battery applications and/or in articles that have at least one thermally sensitive component that is capable (generally upon failure of that component) of releasing energy that results in a transient temperature greater than about 300° C. Lithium-ion batteries are formed of a plurality of individual lithium-ion battery cells placed adjacent to each other. In normal operation, lithium-ion batteries swell over time. In lithium-ion battery modules, where the lithium-ion battery cells are placed adjacent to each other, the swelling can impart a pressure or stress on materials placed between adjacent cells. This stress can be in excess of 1 MPa, depending on the design of the lithium-ion battery cells and the module in which they are placed, and is a factor that should be considered when developing an insulative composite to be placed between the cells to mitigate or even prevent a thermal runaway. The pressure exerted on conventional insulation material positioned between the cells can reduce the thickness of the insulation material, thereby resulting in a reduction in both thermal resistance and the potential to mitigate a thermal runaway. It is therefore important to create an insulative composite that may be placed between the lithium-ion battery cells which has very low compressibility (e.g., less than 35% compressible at 1 MPa). FIG. 6 is a graphical illustration of the compressibility of the gel processed insulative composite (Example 1) and a non-gel processed insulative composite described in Comparative Example 1.

In addition, the insulative composite has strength in the z-direction. The need for z-strength arises from the desire for the insulating materials to be easily handled in a high automated production environment. In order for the electrification of vehicles to have a global impact on the reduction of CO₂, the vehicles need to be efficient at a massive scale, which is only possible using automation. The desire to automate creates new challenges in the design of materials that may be used in an automated process. The materials need to be able to handle the dynamic forces of high throughput automation. Such dynamic forces can be challenging for insulating materials because insulating materials are often fragile because of their low densities resulting from the high air content in them. The fragility of the insulting materials can be managed to some extent in the planar dimension of the insulation material with the use of cover layers or reinforcing scrims. However, it is very difficult to do so in the direction perpendicular to the planar dimension, i.e., the z-direction. Therefore, the high temperature gel processed insulative composite is robust and has a high tensile strength in the z-direction, referred to herein as “high z strength”. Furthermore, the high z-strength of the gel processed insulative composite reduces cohesive failure when bonded directly to the cell or other battery pack components and/or allows unique layering to other materials. Additionally, the gel processed insulative composite is non-particulating, and material does not slough off during assembly or in use. Table 2 is a tabular representation of the z-strength of the gel processed insulative composites and Comparative Example 1 (non-gel processed insulative composite).

In certain applications, such as in lithium-ion batteries, a high temperature thermal event may occur. The high temperature thermal event may be sufficient to damage adjacent lithium-ion battery cells and includes situations where exposure of the adjacent lithium-ion battery cells to the high temperature event may trigger a secondary high temperature event in adjacent lithium-ion battery cells (i.e., runaway events in failing lithium-ion batteries). As such, there is a need for an insulative barrier that protects adjacent lithium-ion battery cells from exposure to high (damaging) temperatures. As demonstrated in the assay described herein, one side (“challenge side”) of a thin sheet (approximately 1 mm thick) of a gel processed insulative composite was compressively contacted with an approximately 800° C. heated stainless steel mass. The average maximum temperature on the opposing side of the thin sheet (“protected side”) was significantly lower. In some embodiments, high temperature gel processed insulative composites capable of functioning as a heat propagation barrier are those capable of limiting the average maximum temperature on the protected side to 250° C. or less when the challenge side is exposed to a temperature of approximately 800° C. when following the Protective Heat Propagation Barrier Testing Assay described below.

High temperature gel processed insulative composites are those capable of providing at least about 70%, at least about 73%, at least about 75%, at least about 80%, at least about 85%, at least about 90% or at least about 95% (with 100% being the maximum or the total % equals 100%) reduction in observed maximum temperature (i.e., on the protected/insulated side) when subjected to a temperature (i.e., on the challenge side) of at least 500° C., preferably within a temperature range from about 500° C. to about 1200° C.

In some embodiments, as will be discussed in more details below, the thermal insulative composite with a thermoplastic polymer scaffold described herein enables compatibility with ultrasonic bonding. Thus, no adhesive layers are required to achieve a stable bond for bonding two or more layers of the thermal insulative composite together or to a different material. In some embodiments, the insulative composite is formed by extruding a thermoplastic resin (e.g., UHMWPE) with insulating particles (e.g., fumed silica or aerogel) using a suitable extrusion method (e.g., gel process). In some embodiments, the insulative composite may contain additional components, such as opacifiers (e.g., silicon carbide) to enable low conductivity at high temperature.

The insulative composite as described herein including a thermoplastic scaffold has substantial polymer connectivity in the z-direction and significantly lower melt viscosity compared to other insulative materials such as insulative materials containing ePTFE. In some embodiments, the insulative composite includes insulating particles durably enmeshed in a polymer matrix such that the surface of the insulative composite is non-shedding, which makes the material capable of being ultrasonic bonded. In some embodiments, a multilayer insulative composite is formed via ultrasonic bonding at least one layer of insulative composite as described herein to a second layer of material, a diffused bonded portion formed between the two or more layers is characterized by an absence of an adhesive bond.

### Insulative Particles

The term “insulative particles” refers to insulative particles that include at least one of: fumed silica, amorphous silica, colloidal silica, precipitated silica, fused silica, silica gel, aerogels (such as silica-based aerogels), silica xerogel, silicates (such as calcium silicate), fumed metal oxides (such as fumed alumina, fumed titania, fumed blends of silica/alumina/titania), and combinations thereof. In some embodiments, the thermally insulative particles may be modified to contain functional groups to alter the relative hydrophilicity/hydrophobicity of the particles (e.g., fumed hydrophobic silica). In some embodiments, the insulative particles may consist solely of fumed silica particles. In some embodiments, aerogel particles (such as silica-based aerogels) may be present in the insulative particles but may not form the total amount of particles present in the insulative particles.

The amount of insulative particles present within the insulative composite may be at least about 40 wt % (based on the total weight of insulative particles), at least about 45 wt %, at least about 50 wt %, at least about 55 wt %, at least about 60 wt %, at least about 65 wt %, at least about 70 wt %, at least about 75 wt %, at least 80 wt %, at least about 85 wt %, at least about 90 wt %, at least about 95 wt %, or at least about 96 wt %. In some embodiments, the insulative particles are present within the insulative composite in an amount from about 40 wt % to about 96 wt %, from about 45 wt % to about 96 wt %, from about 50 wt % to about 96 wt %, from about 55 wt % to about 96 wt %, from about 60 wt % to about 96 wt %, from about 65 wt % to about 96 wt %, from about 70 wt % to about 96 wt %, from about 75 wt % to about 96 wt %, from about 80 wt % to about 96 wt %, from about 85 wt % to about 96 wt %, from about 90 wt % to about 96 wt %, or from about 93 wt % to about 96 wt %.

### Gel Processed Polymer Matrix

The use of a gel processed polymer matrix to create the high temperature insulative composites enables the formation of thin, strong, and flexible form factors (e.g., films, sheets, and tubes) having the insulative particles and other components distributed within the gel processed polymer matrix. The gel processed polymer matrix may be any polymer that can be processed by a gel process, such as, but not limited to, extrusion, injection molding, compression molding, and calendering. It is to be appreciated that there is no imbibing step to introduce the aerogel particle(s), reinforcement fiber(s), and/or other additional components into the gel processed polymer matrix. As discussed above, thin and flexible form factors are important in lithium-ion battery cells and modules.

In some embodiments, the high temperature gel processed insulative composites may have a thickness up to about 25 mm. In some embodiments, the high temperature gel processed insulative composite has a thickness from about 0.1 mm to about 20 mm. The gel processed insulative composite may have a thickness from about 0.1 mm to about 2 mm, from about 0.2 mm to about 2 mm, from about 0.5 mm to about 2 mm, from about 0.75 mm to about 2 mm, from about 1 mm to about 2 mm, from about 1.25 mm to about 2 mm, from about 1.5 mm to about 2 mm, from about 1.75 mm to about 2 mm, from about 0.1 mm to about 1.5 mm, from about 0.25 to about 1.5 mm, from about 0.5 mm to about 1.5 mm, from about 0.75 mm to about 1.5 mm, from about 1 mm to about 1.5 mm, from about 1.25 mm to about 1.5 mm, from about 0.1 mm to about 1 mm, from about 0.25 mm to about 1 mm, from about 0.5 mm to about 1 mm, or from about 0.75 mm to about 1 mm. In some embodiments, the high temperature gel processed insulative composite has a thickness from about 2 mm to about 4 mm, from about 2.25 mm to about 4 mm, from about 2.5 mm to about 4 mm, from about 2.75 mm to about 4 mm, from about 3 mm to about 4 mm, from about 3.25 to about 4 mm, from about 3.5 mm to about 4 mm. In some embodiments, the insulative composite has a thickness from about 4 mm to about 10 mm, from about 5 mm to about 10 mm, from about 6 mm to about 10 mm, from about 7 mm to about 10 mm, from about 8 mm to about 10 mm, or from about 9 mm to about 10 mm. In some embodiments, the gel processed insulative composite has a thickness from about 10 mm to about 25 mm, from about 15 mm to about 25 mm, from about 20 mm to about 25 mm. In some embodiments, the thickness of the high temperature insulative composite is greater than or equal to about 0.1 mm, greater than or equal to about 0.5 mm, less than or equal to about 1 mm, less than or equal to about 1.5 mm, less than or equal to 2 mm, less than or equal to 4 mm, less than or equal to 10 mm, less than or equal to 25 mm.

The gel processed polymer matrix may be prepared from any conventional gel processing. Non-limiting examples of gel processed polymers include polyethylene, UHMWPE, polypropylene, ethylene-propylene copolymers, polyoxymethylene, polyethylene oxide, polyamides, polyethyleneterephtalate, polyacrylonitrile, polyvinylalcohol, polylactic acid (PLA), polyhydroxyalkanoates, polyvinylidenefluoride, and combinations thereof.

In some embodiments, the gel processed polymer matrix is a gel processed polyethylene matrix having a number average molecular weight greater than about 200,000 g/mol, 500,000 g/mol, greater than about 1,000,000 g/mol, greater than about 1,500,000 g/mol, greater than about 2,000,000 g/mol, greater than about 2,500,000 g/mol, or greater than about 3,000,000 g/mol, or greater than about 5,000,000 g/mol, or greater than 8,000,000 g/mol, or greater than 10,000,000 g/mol, or even higher. The gel processed polymer matrix may range from about 200,000 g/mol to about 12,000,000 g/mol, from about 500,000 g/mol to about 12,000,000 g/mol, or from about 1,000.00 g/mol to about 12,000,000 g/mol, or from about 1,000,000 to about 10,000,000 g/mol. In some embodiments, the gel processed polymer may include a blend of various number average molecular weights of the gel processed polymer within the gel processed polymer matrix. In some embodiments, the blend includes being both high molecular weight (e.g., 3,000,000 g/mol) and low molecular weight (e.g., 200,000 g/mol) gel processed polyethylene. It is to be appreciated that any blend of number average molecular weight gel processed polyethylene matrix is within the purview of this disclosure.

The amount of gel processed polymer matrix present in the high temperature insulative composite is about 35 wt % or less, about 30 wt % or less, about 25 wt % or less, about 20 wt % or less, about 15 wt % or less, about 10 wt % or less, about 7 wt % or less, about 5 wt % or less, or about 4 wt % or less. The gel processed polymer matrix may be present in the high temperature insulative composite in an amount from about 1 wt % to about 35 wt %, from about 1 wt % to about 30 wt %, from about 1 wt % to about 25 wt %, from about 1 wt % to about 20 wt %, from about 1 wt % to about 15 wt %, from about 1 wt % to about 10%, from about 1 wt % to about 5 wt %, or from about 1 wt % to about 4 wt %. In other embodiments, the amount of gel processed polymer matrix ranges from about 0.5 wt % to about 20 wt %, from about 0.5 wt % to about 15 wt %, from about 0.5 wt % to about 10 wt %, from about 0.5 wt % to about 5 wt %, or from about 0.5 wt % to about 4 wt %.

The high temperature insulative composite can be formed into relative thin form factors (e.g., sheets). Thin form factors of the high temperature insulative composite are attractive for use in electronic devices and/or batteries where an undesirable high temperature thermal event may occur. In one embodiment, the high temperature insulative composite may be formed into any extrudable profile or article or injection molded shape or molded article. One non-limiting example includes a cylindrical cell battery holder.

### Additional Components

The insulative composite may further include one or more additional components in an amount less than about 35 wt %. In some embodiments, the additional components are present in the gel processed insulative composite in an amount less than about 30 wt %, less than about 25 wt %, less than about 20 wt %, less than about 15 wt %, less than about 10 wt %, or less than about 5 wt %. In some embodiments, the additional components may be present in an amount from about 5 wt % to about 35 wt %, from about 5 wt % to about 30 wt %, from about 10 wt % to about 25 wt %, from about 10 wt % to about 20 wt %, from about 5 wt % to about 20 wt %, or from about 5 wt % to about 15 wt %. Non-limiting additional components include, but not limited to, flame retardant materials, additional polymers, opacifier(s) (as discussed below), reinforcement fiber(s) (as discussed below) antioxidant(s), intumescent material(s), oxygen scavenger(s), dyes, plasticizers, and thickeners.

### Opacifiers

In some embodiments, the insulative composite includes at least one opacifier. Opacifiers reduce radiative heat transfer and improve thermal performance. Non-limiting examples of suitable opacifiers for use in the insulative composite include, but are not limited to, carbon black, titanium dioxide, aluminum oxide, zirconium dioxide, iron oxides, silicon carbide, molybdenum silicide, manganese oxide, a polydialkylsiloxane where the alkyl groups contain 1 to 7 carbon atoms, or any combination thereof. In some embodiments, the opacifier may be used in the form of a finely dispersed powder. In at least one embodiment, the amount of opacifier present in the high temperature insulative composite (based on the total weight of the insulative composite) is up to about 35 wt %, up to about 30 wt %, up to about 25 wt %, up to about 20 wt %, up to about 15 wt %, up to about 10 wt %, or up to about 5 wt %. In some embodiments, the opacifier(s) is present in the insulative composite (based on the total weight of the insulative composite) in an amount less than equal to 20 wt %. In some embodiments, the amount of opacifier(s) present in the high temperature gel processed insulative composite (based on the total weight of the gel processed insulative composite) may be from about 5 wt % to about 35 wt %, from about 5 wt % to about 30 wt %, from about 5 wt % to about 25 wt %, from about 5 wt % to about 20 wt %, from about 5 wt % to about 15 wt %, or from about 5 wt % to about 10 wt %.

### Reinforcement Fiber

In some embodiments, the high temperature insulative composite also includes at least one reinforcement fiber. In one embodiment, the reinforcement fiber may be chopped fibers having a size from about 0.1 mm to about 25 mm, from about 0.1 to about 19 mm, from about 0.1 mm to about 15 mm, from about 0.1 mm to about 13 mm, from about 0.1 mm to about 10 mm, from about 0.1 mm to about 7 mm, or from about 0.1 mm to about 5 mm. A variety of reinforcement fibers may be used and may include fibers such as, but not limited to, carbon fibers, glass fibers, aluminoborosilicate fibers, or combinations thereof. In some embodiments, the reinforcement fibers are chopped glass fibers. The amount of reinforcement fibers present in the high temperature insulative composite may be up to about 25 wt %. In some embodiments, the reinforcement fiber is present in an amount from about 1 wt % to about 25 wt %, from about 2 wt % to about 20 wt %, from about 3 wt % to about 20 wt %, from about 5 wt % to about 15 wt %, from about 8 wt % to about 15 wt %, from about 9 wt % to about 15 wt %, or from about 10 wt % to about 15 wt %. In some embodiments, the reinforcement fiber is present in an amount from about 1 wt % to about 10 wt %, from about 2 wt % to about 10 wt %, from about 3 wt % to about 10 wt %, from about 4 wt % to about 10 wt %, from about 5 wt % to about 10 wt %, from about 6 wt % to about 10 wt %, from about 7 wt % to about 10 wt %, or from about 8 wt % to about 10 wt %. In some embodiments, the reinforcement fiber(s) may be present in the insulative composite in an amount from about 2 wt % to 10 wt %, from about 3 wt % to about 10 wt %, from about 4 wt % to about 10 wt %, from about 5 wt % to about 9 wt %, or from about 6 wt % to about 9 wt %.

### Mechanical Performance

### Z-Strength

The insulative composite described herein is not only a protective heat propagation barrier when subjected to a high temperature event, the insulative composite also possesses mechanical properties superior to comparative insulative materials. One such property includes a z-strength greater than about 25 N. In some embodiments, the z-strength of the insulative composite is greater than about 25 N, greater than about 30 N, greater than about 35 N, greater than about 40 N, greater than about 45 N, greater than about 50 N, greater than about 55 N, greater than about 60 N, greater than about 65 N, greater than about 70 N, or greater than about 75 N, or greater than about 100 N, or greater than about 250 N. In some embodiments, the z-strength may range from about 25 N to about 1000 N, from about 25 N to about 750 N, from about 25 N to about 700 N, from about 25 N to about 600 N, from about 25 N to about 550 N, from about 30 N to about 1000 N, from about 35 N to about 1000 N, from about 40 N to about 1000 N, from about 45 N to about 1000 N, from about 50 N to about 1000 N, from about 55 N to about 1000 N, from about 60 N to about 1000 N, from about 65 N to about 1000 N, or from 70 N to about 1000 N. In some embodiments, the z-strength may range from about 25 N to about 750 N, from about 25 N to about 700 N, from about 25 N to about 650 N, from about 25 N to about 600 N, or from about 25 N to about 550 N.

### Compressibility

Another mechanical property possessed by the insulative composite is compressibility. In some embodiments, the compressibility is less than about 35% at 1 MPa. The compressibility may range from about 1% to about 35% at 1 MPa, from about 1% to about 30% at 1 MPa, from about 1% to about 25% at 1 MPa, from about 1% to about 20% at 1 MPa, from about 1% to about 15% at 1 MPa, from about 1% to about 10% at 1 MPa, from about 1% to about 9% at 1 MPa, from about 1% to about 8% at 1 MPa, from about 1% to about 7% at 1 MPa, from about 1% to about 6% at 1 MPa, from about 1% to about 5% at 1 MPa.

### Average Maximum Temperature

The insulation composite has an average maximum temperature less than about 250° C., less than about 240° C., less than about 230° C., less than about 220° C., less than about 210° C., less than about 200° C., less than about 175° C., less than about 150° C., or less than about 125° C. The average maximum temperature may range from about 200° C. to about 250° C., from about 200° C. to about 240° C., from about 200° C. to about 230° C., from about 200° C. to about 225° C., from about 200° C. to about 210° C.; from about 215° C. to about 250° C., from about 215° C. to about 240° C., from about 215° C. to about 230° C., or from about 215° C. to about 220° C.

In some embodiments, the gel processed insulative composite includes an average maximum temperature less than 250° C., a Z-strength greater than 25 N, a compressibility less than 35% at 1 MPa.

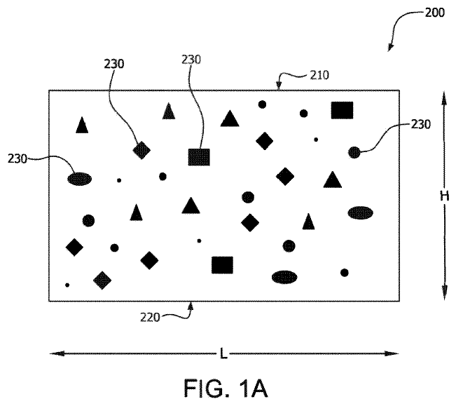

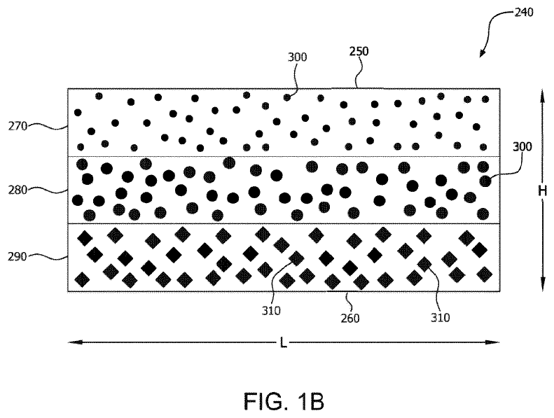

In some embodiments, the insulative particles and additional components of the high temperature insulative composite may be located through the thickness of the gel processed polymer matrix. As illustrated in FIG. 1A, the particulate components 230 are located fairly equally throughout the microstructure of the gel processed polymer matrix (membrane) of the high temperature insulative composite 200. The high temperature insulative composite 200 has a challenge side 210, a protected side 220, a height (H) and a length (L). It is to be appreciated that, in some embodiments (not illustrated), the insulative particles and additional materials may be located on a surface of the insulative composite.

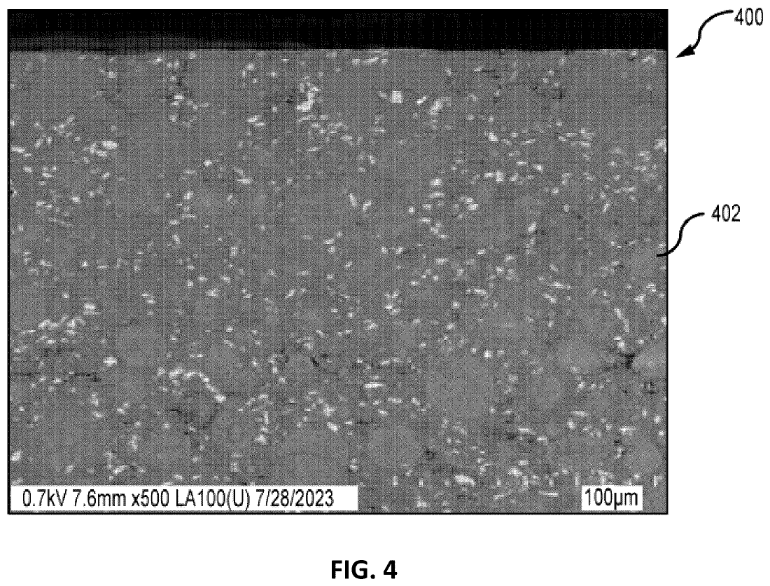

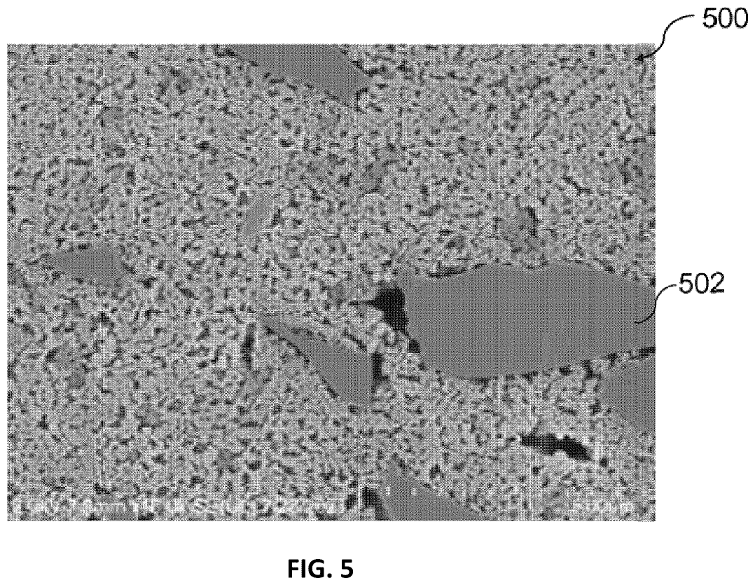

The insulative composite may be formed of a composite (e.g., one layer) as generally depicted in FIG. 1A or as a multi-layer stack high temperature insulative composite (e.g., multiple, individual layers) as generally depicted in FIG. 1B. In a multi-layer stack high temperature insulative composite, each layer may have therein a particulate that has a different chemical composition, a different particle size, a different particle size distribution, or a different particle distribution. In one embodiment, opacifiers having differing properties such as composition, size, and/or shape may be distributed in various layers throughout the thickness of the high temperature insulative composite, such as is described in Hu et al. (Radiative Characteristics of Opacifier Loaded Silica Aerogel Composites, 2013). FIG. 4 is a scanning electron micrograph (SEM) of a cross-section of a gel processed insulative composite 400 showing opacifier particles 402 distributed throughout the gel processed insulative composite 400. FIG. 5 is an SEM of a portion of the SEM of FIG. 4. As shown in FIG. 5 including a blown-up view of the SEM of FIG. 4, opacifier particles 502 are distributed throughout the gel processed insulative composite 500.

In the multi-layer stack high temperature insulative composite illustrated in FIG. 1B, for ease of illustration, of the particulate components present in the multi-layer stack high temperature insulative composite, only the opacifiers are depicted. FIG. 1B is a schematic cross-section of one embodiment of a multi-layer stack high temperature insulative composite having multiple layers. As shown, the multi-layer stack high temperature insulative composite 240 has a height (H) and a length (L). The multi-layer stack high temperature insulative composite 240 contains a challenge side 250 and a protected side 260.

In the embodiment depicted in FIG. 1B, the height (H) is divided into three layers, namely Layer A 270, Layer B 280, and Layer C 290. In some embodiments, Layer A 270, Layer B 280, and Layer C 290 may contain the same type of opacifier but with different size distributions. In other embodiments, Layer A 270, Layer B 280, and Layer C 290 may contain different types of opacifier with different size distributions. As shown in FIG. 1B, Layer A 270 has a first opacifier 300 with a first size distribution, Layer B 280 has a first opacifier 300 with a second size distribution, and Layer C 290 has a second opacifier 310 with the first size distribution. The first opacifier 300 may be silicon carbide and the second opacifier 310 may be carbon black, although this is exemplary in nature and is not meant to restrict the purview of this disclosure. In some embodiments, the particulate components themselves may be different in each layer, or only in certain layers. In other embodiments, the particulate components are the same in each layer, but each layer has a different size distribution. Thus, each layer in a multi-layer stack high temperature insulative composite may include one or more particulate components(s) that have a different chemical composition, a different particle size, and/or a different particle size distribution within each layer (or only within certain layers).

In forming a multi-layer stack high temperature insulative composite, each layer is separately formed as described below and then layered or stacked upon each other in a manner to obtain a desired orientation of the layers in the multi-layer stack high temperature insulative composite. The layers may be bound to each other in any conventional manner such as laminating, adhering, or other bonding techniques to form a multi-layer high temperature insulative composite.

### Articles Including a High Temperature Insulative Composite

In one embodiment, a thermally insulative article includes a first component that is capable of generating a high temperature event (i.e., a first temperature), a second component to be protected against exposure to the first temperature caused by the high temperature event, and a high temperature gel processed insulative composite. The high temperature gel processed insulative component is positioned between the first component and the second component. In some embodiments, the first component is a first battery cell of a lithium-ion battery, and the second component is a second battery cell of a lithium-ion battery. In some embodiments, the first component is a first battery cell of a solid-state battery, and the second component is a second battery cell of a solid-state battery. The high temperature insulative component may be in the form of a sheet, film or tape. A first side of the high temperature gel processed insulative component may be oriented toward the first component and a second side of the high temperature gel processed insulative component may be oriented toward the second component. In some embodiments, the insulative component of the article includes a single layer of high temperature insulative composite as described herein. In certain embodiments, the insulative component of the article includes multiple layers of high temperature insulative composite where each layer includes one or more particulate components(s) that have a different chemical composition, a different particle size, and/or a different particle size distribution within each layer (or only within certain layers). In some embodiments, as described in more details below with regard to the multilayer insulative composite, the insulative component of the article includes a multilayer insulative composite including an insulative composite layer bonded to at least one additional layer defining a diffused bonded portion without use of an adhesive. In some embodiments, the diffused bonded portion includes an interdiffused bonded portion. In some embodiments, the bonded portion is defined by an ultrasonic bond. In some embodiments, the bonded portion has a higher density than a density of the insulative composite layer.

The thermally insulative article may also include one or more support materials in the form of supportive layer(s) on one or more sides of the high temperature insulative composite. In one embodiment, the support layer(s) is a polymer layer, a woven layer, a knit layer, a non-woven layer, or any combination thereof. The polymer layer can be a nonporous layer, a porous layer, a microporous layer, and any combination thereof. Non-limiting additional support layers include a fluoropolymer membrane (e.g., polytetrafluoroethylene membrane), an expanded fluoropolymer membrane (e.g., expanded polytetrafluoroethylene membrane), a polyolefin membrane (e.g., polyethylene membrane), a metal film, electrical insulation, an adhesive layer, mica, or any combination thereof. Support layer(s) may be included in the thermally insulative article by laminating, adhering, or otherwise bonding one or more support layers to the high temperature insulative composite. For example, the high temperature insulative composite may be in the form of a sheet or a film having a first side and a second side, where the thickness is less than the width and/or length directions. One or more support layers can be adhered to the first side, to the second side or to both the first and the second side of the high temperature insulative composite.

The one or more support layers can be adhered to the high temperature insulative composite using an adhesive, welding, calendering, coating, or any combination thereof. In some embodiments, the thermally insulative article can include multiple layers. For example, the high temperature insulative composite can have a layer of polyethylene bonded to one or both sides, resulting in a high temperature insulative composite having a 2-layer or a 3-layer structure. One or more textile layers, for example, a woven, a knit, a non-woven or any combination thereof, may be adhered to high temperature insulative composite. An adhesive may be applied to the high temperature insulative composite, to the textile or to both in a continuous or a discontinuous manner, as is well-known in the art.

The textile layer(s) can be a woven, a knit, a non-woven or any combination thereof. In some embodiments, the woven, knit or non-woven textile may be a flame resistant woven, a flame-resistant knit, or a flame-resistant non-woven textile. Suitable textile layers are well-known in the art and may include elastic and non-elastic textiles, such as, for example, LYCRA®, polyurethane, polyester, polyamide, acrylic, cotton, wool, silk, linen, rayon, flax, jute, flame resistant textiles, such as, for example, NOMEX® aramid (available from Du Pont, Wilmington, DE), aramids, flame resistant cotton, polybenzimidazole, poly p-phenylene-2,6-bezobisoxazole, flame resistant rayon, modacrylics, modacrylic blend, polyamine, carbon, fiberglass or any combination thereof.

### Multilayer Insulative Composite

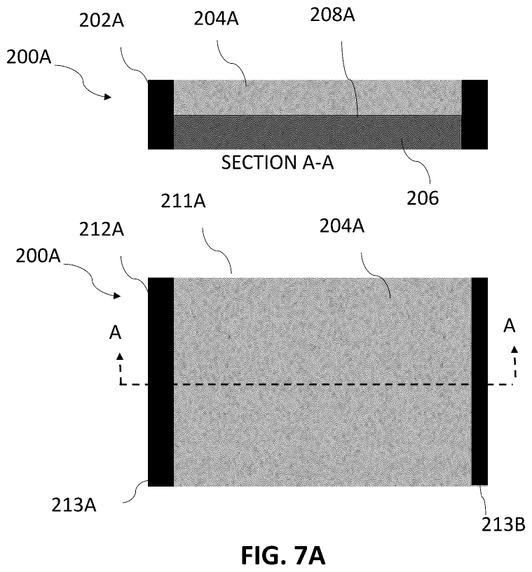

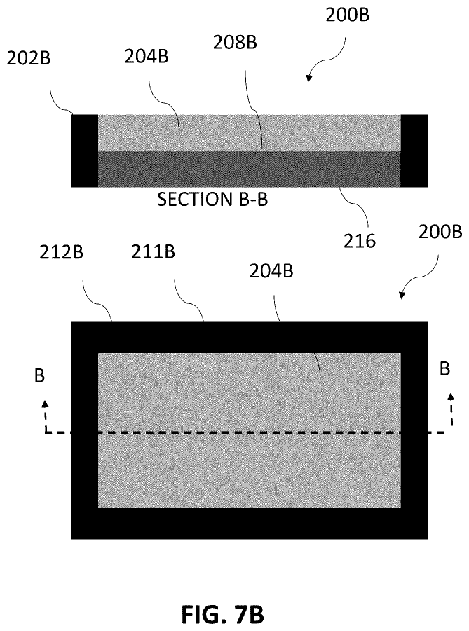

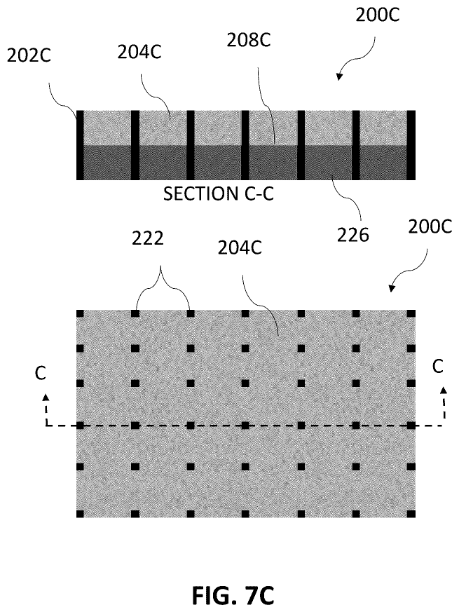

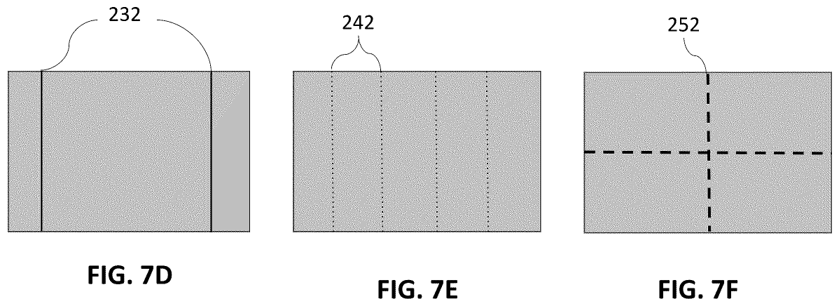

FIGS. 7A, 7B, and 7C each show a top view and a cross-section view of different multilayer insulative composites, in accordance with various embodiments herein.

In some embodiments, the insulative composite may be part of a multilayer insulative composite (e.g., multilayer insulative composite 200A, 200B, and 200C). The multilayer insulative composite may include a stack of layers including the insulative composite as a layer in the stack (e.g., insulative composite layer 204A, 204B, and 204C). In some examples, more than one layer of the stack may be layers of insulative composite. In some embodiments, each layer may have therein a particulate that has an identical chemical composition, an identical particle size, and/or an identical particle distribution. In some embodiments, each layer may have therein a particulate that has a different chemical composition, a different particle size, and/or a different particle distribution. In some embodiments, one or more layers of the multilayer insulative composite may include a compressible foam.

The insulative composite layer of the multilayer insulative composite may have any of the characteristics described above and/or below with respect to the insulative composite. For example, in some embodiments the insulative composite layer may include greater than about 50 wt % of insulative particles, less than about 35 wt % of a gel processed polymer matrix, and less than about 35 wt % of a combined total of additional components, based on the total weight of the insulative composite layer. In some embodiments, the insulative composite layer may have at least one of an average maximum temperature less than about 250° C., a Z-strength greater than about 25 N, and/or a compressibility less than about 35% at 1 MPa.

In addition to an insulative composite layer, the multilayer insulative composite may include one or more additional layers. For example, the multilayer insulative composite may include a second layer (e.g., second layer 206, 216, and 226) bonded to the insulative composite layer. The bond between the second layer and the insulative composite layer may define a bonded portion (e.g., bonded portion 202), of the multilayer insulative composite. In some embodiments, as described below, the bonded portion may be defined by an ultrasonic bond. The multilayer insulative composite may include any number of layers bonded to one another as described herein. In some embodiments, the bonded portion includes a diffused bonded portion. In certain embodiments, the bonded portion includes an interdiffused bonded portion. In some embodiments, the bonded portion includes a localized densified region with a higher density than the density of the insulative composite layer or the density of the second layer.

In some embodiments, the second layer may be similar or identical to the insulative composite layer. For example, the second layer may be a second insulative composite layer with greater than about 50 wt % of insulative particles, less than about 35 wt % of a gel processed polymer matrix, and less than about 35 wt % of a combined total of additional components based on the total weight of the second insulative composite layer.

In some embodiments, the second layer may be a different material than the insulative composite layer. For example, the second layer may be a porous layer. In some embodiments, the porous layer has a bulk density of less than about 1.0 g/cm³, or less than about 0.9 g/cm³, less than about 0.8 g/cm³, less than about 0.7 g/cm³, less than about 0.6 g/cm³, less than about 0.5 g/cm³, less than about 0.4 g/cm³, less than about 0.3 g/cm³, less than about 0.2 g/cm³, less than about 0.1 g/cm³, and for each of the foregoing, greater than or equal to 0.01 g/cm³, or within any range encompassed by two of the foregoing values as endpoints. In some embodiments, for example, the second layer may be a compressible foam layer. In some examples, the compressible foam layer may include a polyurethane foam, a polyethylene foam, a polyvinylchloride foam, or a silicone porous foam.

In some embodiments, the multilayer insulative composite may include any number of layers, including any number of insulative composite layers. For example, a multilayer insulative composite may include more than two insulative composite layers, from 3 to 10 insulative composite layers, or more than 10 insulative composite layers. Each of the insulative composite layers may be bonded to each adjacent layer (whether the adjacent layer is an insulative composite layer or a layer of a different material) using ultrasonic bonding.

Using adhesive to attach multiple layers of insulative material together may detrimentally affect the thermal properties of the layer stack. For example, adhesive between layers of insulative material may reduce thermal insulative properties of the layer stack due to adhesive migration into the porous insulative material which disadvantageously increases its thermal conductivity. In addition, heat may cause some adhesives to lose their capacity to bond the layers together during a high temperature event. Moreover, some adhesives are flammable and thus increase risk of fire during a high temperature event.

According to embodiments of this disclosure, the layers of the multilayer insulative composite may advantageously be attached to one another using ultrasonic bonding. The insulative composite described herein may be especially amenable to ultrasonic bonding, as the insulative composite provides a spatially uniform thermoplastic scaffold that is miscible with other layers of the multilayer stack when energy is applied to the insulative composite. For example, in some embodiments, ultrasonic energy may be applied to portions (e.g., localized regions) of the insulative composite and an adjacent layer (e.g., a second layer) at one or more interfaces of the insulative composite and the second layer. Pressure and the high-frequency vibrations caused by the ultrasonic energy may create friction and heat at the one or more interfaces, causing the insulative composite to at least partially melt at the one or more interfaces to which ultrasonic energy is applied, allowing those portions of the insulative composite and the second layer to mix together (e.g., a polymer from the insulative composite layer diffuses across the interface of the two layers). Upon removal of the ultrasonic energy, those portions of the insulative composite and the second layer may cool and solidify, resulting in a bonded portion of the multilayer insulative composite that holds the insulative composite layer and the second layer together. Because of the diffused bonded portion, the multilayer insulative composite may be characterized by an absence of any adhesive between the insulative composite layer and the second layer.

In some embodiments, the multilayer insulative composite may include a first insulative composite layer and a second insulative composite layer. Ultrasonic energy may be applied to portions (e.g., localized regions) of the first insulative composite layer and the second insulative composite layer at one or more interfaces between the first insulative composite layer and the second insulative composite layer. Those portions (e.g., localized regions) of the two insulative composite layers may both at least partially melt in response to the ultrasonic energy, allowing the melted material to flow and mix. When the ultrasonic energy is terminated, those portions of the two insulative composite layers may cool and solidify together to form an interdiffused bonded portion of the multilayer insulative composite.

In some embodiments, the multilayer insulative composite may include an insulative composite layer, and a second porous layer. Ultrasonic energy may be applied to portions (e.g., localized regions) of the insulative composite layer and the porous layer at one or more interfaces between the insulative composite layer and the porous layer. Those portions (e.g., localized regions) of the insulative composite layer may at least partially melt in response to the ultrasonic energy, allowing the melted material to flow and penetrate the structure of the porous layer. When the ultrasonic energy is terminated, those portions of the insulative composite layer may cool and solidify around and within the porous layer, forming a diffused bonded portion of the multilayer insulative composite, and holding the insulative composite layer and the porous layer together.

Ultrasonic energy may be applied to targeted portions of an insulative composite layer and a second layer of a multilayer insulative composite to form bonded portions in patterns around and/or within the layers of the multilayer insulative composite. For example, as shown in FIG. 7A, multilayer insulative composite 200A may include an insulative composite layer 204A and a second layer 206. The insulative composite layer 204A and the second layer 206 may have respective surfaces positioned adjacent one another to form an interface 208A between the insulative composite layer 204A and the second layer 206.

In some embodiments, the respective surfaces of the insulative composite layer 204A and the second layer 206 may be coextensive. For example, as shown in FIG. 7A, the respective surfaces of the insulative composite layer 204A and the second layer 206 may both define rectangles (in other examples, the respective surfaces may define another shape) of substantially similar size. In some embodiments, the respective surfaces may define shapes of different sizes. In some examples, the insulative composite layer may define a geometric shape, for example, a rectangle, a circle, a triangle, a square, an oval, a polygon, etc.

The edges of the shape defined by the insulative composite layer 204A at the interface 208A may define an outer perimeter 211 of the insulative composite layer 204A. In some examples, as shown in FIGS. 7A and 7B, the bonded portions 202A and 202B include edge bonds 212A and 212B along the outer perimeters 211A and 211B of the insulative composite layers 204A and 204B. The edge bonds may be defined along the outer perimeter of the insulative composite layer and spanning from 10% to 100% of a total length of the outer perimeter of the insulative composite layer. For example, as shown in FIG. 7A, edge bond 212A spans less than 100% of the total length of the outer perimeter 211A of the insulative composite layer 204A. As shown in FIG. 7B, the edge bond 212B spans 100% of the total length of the outer perimeter 211B of the insulative composite layer 204B. In the example of FIG. 7B, the edge bond 212B connects insulative composite layer 204B with the second layer 216 at an edge of the interface 208B between the insulative composite layer 204B and the second layer 216.

In some examples, the edge bond may include one or more edge bond portions. In the example of FIG. 7A, edge bond 212A includes edge bond portions 213A and 213B. The edge bond portions 213A and 213B may be adjacent to the outer perimeter 211A of the insulative composite layer 204A, on the outer perimeter 211A, or both adjacent to and on the outer perimeter 211A of the insulative composite layer 204A. In some embodiments, the edge bond may be defined by a plurality of discontinuous edge bond portions along the outer perimeter of the insulative composite layer. For example, as shown in FIG. 7A, the edge bond 212A is defined by edge bond portions 213A and 213B, where the edge bond portions 213A and 213B are discontinuous. In the example of FIG. 7B, the edge bond 212B is defined by a continuous bond along the outer perimeter 211B of the insulative composite layer 204B.

In some embodiments, the bonded portion of the multilayer insulative composite may include one or more interior bond portions defined within the outer perimeter of the multilayer insulative composite between opposing faces of the insulative composite layer and the second layer. In the example of FIG. 7C, bonded portion 202C includes a plurality of bonded portions 222 defined both along the perimeter of the insulative composite layer 204C, as well as within the outer perimeter defined by the insulative composite layer. Bonded portions 222 are defined between opposing faces of the insulative composite layer 204C and the second layer 226. For example, bonded portions 222 pass through interface 208C and penetrate within both the insulative composite layer 204C as well as the second layer 226.

In some embodiments, the bonded portions of the multilayer insulative composite may be defined over a surface area of the opposing faces of the insulative composite layer and the second layer from about 0.1% to 100% of the surface area of the opposing faces. In some examples, the bonded portions may be defined from about 0.1% to 20% of the surface area of the opposing faces. In some embodiments, the multilayer insulative composite may include interior bond portions. In some examples, the interior bond portions may be defined from about 0.1% to 20% of the surface area of the opposing faces. For example, along the interface 208C between the opposing faces of insulative composite layer 204C and second layer 226, the number of bonded portions 222 that are interior bond portions may define from about 0.1% to 20% of the surface area of the interface 208C.

In some examples, the bonded portions may be arranged in a pattern across the opposing faces of the insulative composite layer and the second layer. In some embodiments, the bonded portions may include edge bond portions and interior bond portions, where the interior bond portions are arranged in a pattern across the opposing faces of the insulative composite layer and the second layer. In the example of FIG. 7C, bonded portions 222 includes edge bond portions and interior bond portions arranged in a dotted grid pattern across the interface 208C between the opposing faces of the insulative composite layer 204C and the second layer 226. Although FIG. 7C only depicts a dotted grid pattern, any number of different patterns may be simultaneously or individually used. In some examples, the pattern may include one or more regular, repeating patterns. In some embodiments, the pattern may include one or more random patterns.

FIGS. 7D-7F show different embodiments of possible bond portion patterns. In the embodiment of FIG. 7D, bonded portion 232 is disposed as two, parallel, interior bond portions defining lines within the multilayer insulative composite. In the embodiment of FIG. 7E, the bonded portion 242 is disposed as a plurality of discontinuous interior bond portions defining parallel dotted lines through the multilayer insulative composite. In the embodiment of FIG. 7F, the bonded portion 252 is disposed as two, perpendicular, interior bond portions defining dashed lines within the multilayer insulative composite. In some embodiments, the bonded portions within a multilayer insulative composite may be symmetric about one or more axes of the multilayer insulative composite.

In some embodiments, the bonded portions may be characterized by one or more shapes. For example, the bonded portions 222 of FIG. 7C are characterized by square shapes extruded through a thickness of the insulative composite layer 204C and a thickness of the second layer 226. In some examples, the edge bond portions may be characterized by one or more shapes and the interior bond portions may be characterized by one or more different shapes. In some embodiments, the interior bond portions may be characterized by any shape (e.g., wherein the shape includes a square, rectangular, rounded, linear, irregular, or polygonal shape).

Although each of FIGS. 7A-7C depict bonded portions 202A-202C persisting entirely through the widths of the insulative composite layers 204A-204C and the widths of the second layers 206, 216, and 226, in some embodiments, the bonded portion of a multilayer insulative composite may not be disposed entirely through the width of the insulative composite layer, and/or may not be disposed entirely through the width of the second layer. Although each of FIGS. 7A-7C depict bonded portions 202A-202C persisting in a substantially straight vertical path through the insulative composite layers 204A-204C and the second layers 206, 216, and 226, in some embodiments, the bonded portion of a multilayer insulative composite may not be disposed in a straight vertical path through the layers of the multilayer insulative composite, and may instead be disposed at an angled path, along a curved path, along a zig-zag path, or any other path through the layers of the multilayer insulative composite.

### Method of Forming Multilayer Insulative Composites

A method for forming a multilayer insulative composite may include providing an insulative composite layer comprising greater than about 50 wt % of insulative particles, less than about 35 wt % of a gel processed polymer matrix, and less than about 35 wt % of a combined total of additional components, based on the total weight of the insulative composite layer, providing a second layer (e.g., a second insulative composite layer, a porous layer, or a compressible foam layer), and applying ultrasonic energy to an edge or a surface of the insulative composite layer and/or the second layer to bond the insulative composite layer to the second layer. In some embodiments, the insulative composite layer has at least one of an average maximum temperature less than about 250° C., a Z-strength greater than about 25 N, and a compressibility less than about 35% at 1 MPa.

In some embodiments, an ultrasonic bond is formed to bond the insulative composite layer to a second layer by using ultrasonic sealing equipment. The ultrasonic sealing equipment is configured to apply pressure and/or ultrasonic energy (e.g., ultrasonic wave) to one or more portions of an insulative composite layer and one or more additional layers as described herein. Pressure and the high-frequency vibrations caused by the ultrasonic energy may create friction and heat at the one or more interfaces, causing at least the insulative composite layer to at least partially melt at the one or more interfaces to which ultrasonic energy is applied, allowing those portions of the insulative composite and the second layer to mix together. Upon removal of the ultrasonic energy, those portions of the insulative composite and the second layer may cool and solidify, resulting in a bonded portion of the multilayer insulative composite that holds the insulative composite layer and the one or more additional layers together without use of an adhesive.

In some embodiments, a sealing or cutting wheel may be used with a selection of various patterns (e.g., flat, radiused edge, stitched, or dotted). In certain embodiments, a roller anvil may be used to enable roll-to-roll processing. The roller anvil may be used for an edge bond and/or an interior bond across at least a portion of a surface of the multilayer insulative composite as described above. In some embodiments, a stationary anvil may be used for batch processing. The stationary anvil may be used for an edge bond and/or an interior bond across at least a portion of a surface of the multilayer insulative composite as described above.

Using ultrasonic energy for forming the multilayer insulative composite described herein offers several advantages. For example, the use of ultrasonic energy may be focused on a localized region, thus allowing the formed multilayer insulative composite to have more discrete differences in density and/or porosity between the bonded portions and the unbonded portions of the multilayer insulative composite. This may be because the unbonded portions are less affected by the ultrasonic energy than conventional methods of bonding (e.g., application of heat). This may allow the unbonded portions of the insulative composite layer(s) of the multilayer insulative composite to better retain their density, porosity, and/or insulative properties.

According to some embodiments, a first layer including an insulative composite as described herein has a first density. The first density may be substantially uniform throughout the insulative composite layer, or there may be a portion of the insulative composite layer having the first density. The insulative composite layer may be bonded to a second layer having a second density via application of ultrasonic energy at a localized region of the insulative composite layer, thus forming a diffused bonded region between the two layers. In some embodiments, for example when the second layer includes a polymer miscible with a polymer forming the insulative composite layer, the diffused bonded region includes an interdiffused bonded region. In some embodiments, the diffused bonded region is a densified region having a higher density than the first density or the second density.

### Lithium-Ion Battery

In some embodiments, the high temperature insulative composite is used as an insulative and protective barrier layer in a high energy battery such as a high energy multi-cell lithium-ion battery. In one aspect, the gel processed insulative composite is used to at least partially or fully enclose or separate one or more lithium-ion battery cells from each other. The thermal isolation the gel processed insulative composite stops or slows any thermal propagation of adjacent cells or modules. The high temperature insulative composite may also be used in module or pack insulation to prevent the propagation of thermal energy or the harmful effects of propagation that may occur when the thermal energy propagates to the opposing side of the high temperature gel processed insulative composite.

Other embodiments in which the high temperature insulative composite may be utilized include, but are not limited to, lithium cells used for electric vehicles (EV), lithium cells used in electrification of aircraft and drones, lithium cells used for residential energy storage (e.g., solar or wind energy storage), lithium cells used for grid energy storage, lithium cells used for energy backup systems for buildings and critical infrastructure, cells used for computer power back-up systems or uninterruptable power systems (UPS), cells used in electric marine vehicles, drones, and unmanned aerial vehicle (UAV), cells used in personal vehicles (e.g., scooters), and cells used in emergency medical backup systems.

In some embodiments, a lithium-ion battery includes a first battery cell capable of a generating a high temperature event comprising a first temperature, a second battery cell to be protected against exposure to the first temperature, and a multilayer insulative composite positioned between the first battery cell and the second battery cell, the multilayer insulative composite having a first side oriented toward the first battery cell and an opposing side oriented towards the battery cell. The multilayer insulative composite may include an insulative composite layer comprising greater than about 50 wt % of insulative particles, less than about 35 wt % of a gel processed polymer matrix, and less than about 35 wt % of a combined total of additional components, based on the total weight of the insulative composite layer, and a second layer bonded to the insulative composite layer to define a bonded portion of the multilayer insulative composite, and optionally wherein the bonded portion is defined by an ultrasonic bond, wherein the insulative composite layer has at least one of an average maximum temperature less than about 250° C., a Z-strength greater than about 25 N, and a compressibility less than about 35% at 1 MPa.

The disclosure of this application has been described above both generically and with regard to specific embodiments. It will be apparent to those skilled in the art that various modifications and variations of the disclosure can be made without departing from the spirit or scope of the disclosure, as defined in the appended claims.

### Test Methods

### Bond Strength

The bond strength test was carried out on an IMASS SP-2100 Peel Tester using the T-peel fixturing and 22 N load cell. A sample was created by laminating or ultrasonically bonding two layers together and then prepared for testing by cutting 10 mm wide strips. The two layers may be comprised of the same material or they may be comprised of different materials. The sample strips are loaded into the tester by clamping the first layer into the first clamp and the second layer into the second clamp. The layers were manually brought to a taught position and then the test was started. The equipment pulls the two layers apart at a rate of 1 mm/second for a total length of 14 mm. The data collection starts after a 4 second delay and the load was averaged for a total of 10 seconds. This average load was used to compare the sample's peel strength.

### Bulk Density

The bulk density of the sample is the density of the solid including all open pores and internal void volume. A die with an area of at least 5 cm² is used to punch a sample for testing. The bulk density is calculated by dividing the sample mass (M) by its volume (V). Sample mass is determined by weighing on an analytical balance of +/−0.01 g sensitivity. Sample volume is calculated by multiplying the sample thickness (P) by its area (A). Sample thickness is determined as described in the Compressibility section below under preload (P). and sample area is determined by the known area of the die.

$$Bulk Density = M / V = M / ( P * A )$$

### Density

The density (D_{local}) of a localized area of a sample was estimated by measuring the thickness of the area. A Scanning Electron Microscope (SEM) image was taken of a cross section of the sample, which was cut either by ion milling or by a cold blade that was frozen in liquid nitrogen. The local thickness (T_{local}) of the sample cross section was measured and local density was calculated by multiplying the bulk density by the ratio of thickness (P) to local thickness (T_{local}). Sample thickness (P) is determined as described in the Compressibility section below under preload.

$${D}_{local} = Bulk Density * ( P / {T}_{local} )$$

### Thermal Conductivity

Thermal conductivity was measured with a Laser Comp Model Fox 50 thermal conductivity analyzer (Laser Comp Saugus, MA). The results of a single measurement were recorded. One 2″ circle sample was measured. For thermal conductivity at 25° C., a temperature differential of 10° C. is used, with hot plate and cold plate at 30° C. and 20° C., respectively. For thermal conductivity at 100° C., a temperature differential of 10° C. is used, with hot plate and cold plate at 105° C. and 95° C., respectively.

### Thermal Conductivity at High Temperature (Above 100° C.)

Thermal conductivity at high temperature was measured using ASTM C1114, in which a thin heater is placed between two identical samples with cold plates on both the top and bottom. For thermal conductivity between 100° C. to 600° C., a temperature differential of 10° C. is used. For thermal conductivity at 800° C., a temperature differential of 30° C. is used.

Optionally, a thermal conditioning step may be carried out prior to the thermal conductivity measurement, in which the testing apparatus including the sample material is heated to 600° C. for 1 hour, then the system is cooled to the test temperature and thermal conductivity of the material is measured.

### Compressibility

Compressibility was measured using a method based on ASTM F36-15. The testing apparatus consisted of an Instron 5966 universal testing machine (Norwood, MA, USA) with an Instron T1223-1021-D penetrator (Norwood, MA, USA), C31209 Instron anvil (Norwood, MA, USA), and 10 kN load cell. The test specimen was a 1.5 in. diameter circle prepared by a die punch. A single test specimen was placed on the anvil and then compressed by the penetrator to a preload of 2 kPa. The thickness under preload (P) was recorded. A load was applied at a rate of 0.01 mm/s until a maximum load of 1 MPa was reached. The thickness under total load (L) was recorded. Compressibility was calculated according to ASTM F36-15 as follows:

$$Compressibility ( \% ) = [ ( P - L ) / P ] \times 100 \%$$

### Thickness

Sample thickness was measured using a ProGauge Thickness Tester (Thwing-Albert Instrument Company, West Berlin, NJ) at a pressure of 50 kPa. The result of a single measurement was recorded.

### Protective Heat Propagation Barrier Assay

A stainless-steel block (“heat accumulator”), having the following dimensions: height 5.5 inches (approximately 13.97 cm); width 3.5 inches (approximately 8.89 cm); and thickness 0.5 inches (approximately 1.27 cm) was obtained. The heat accumulator exhibited a density of 7999.4 kg/m³, a volumetric heat capacity of 617.6 J/kgK, and a calculated sensible energy of 600 kJ. The side of the test material placed in contact with the heated stainless-steel block was referred to herein as the “challenge side”. The opposing side of the test material was referred to as the “protected side”. Two identical test samples (each approximately 1 mm thick) were placed on opposing sides of the rectangular heat accumulator that had been heated to a target temperature of 800° C. to ensure symmetric heat dissipation. Type K thermocouples were used to measure the temperature of the heat accumulator as well as the temperature on the opposing side of each test sample. The average temperature on the opposing side of each test sample was recorded continually over the test duration (time from 0 to 15 minutes) post contact with the heat accumulator and the maximum average temperature observed during the contact period was calculated and recorded.

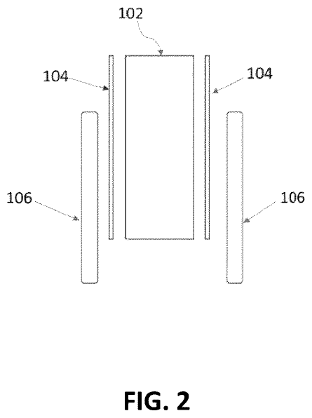

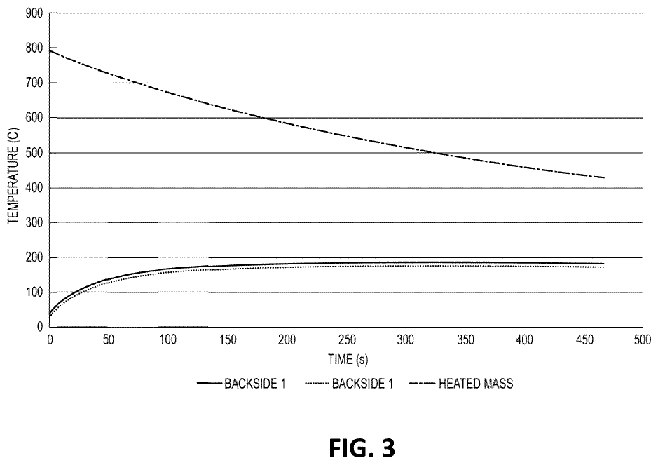

Looking at FIG. 2, to initiate a test, a heat accumulator 102 was heated to approximately 800° C. (e.g., in a furnace). Test samples 104 were placed on opposing sides of the heat accumulator 102. Type-K thermocouples 106 recorded the temperature on the opposite side of each test sample 104 were recorded over a defined time (from 0 min to 15 minutes). The maximum average temperature observed over the defined contact period was calculated and recorded. FIG. 3 is a graph illustrating a representative plot of the heat accumulator temperature and the temperature measured on the opposing sides of the composite insulation sample over test duration.

### Z-Strength

The cohesive strength of the composites was measured under ambient conditions using a TAPPI-541 (Zwick, Germany) device. A 75 mm×130 mm piece of two-sided adhesive tape, such as 9500PC (3M Corporation), was attached to similar sized face of the bottom platen. Composite samples were slit into 25.4 mm×25.4 mm shapes and placed over the tape covered bottom platen. The upper platen, which has identical five 25.4 mm×25.4 mm test areas, was covered with the same two-sided adhesive tape. The upper & bottom platens were mounted in an INSTRON® tensile testing machine (Model 5567; Illinois Tool Works Inc., Norwood, MA) with the two platens aligned at a 90 degree angle to each other. The platens with the sample in between were compressed together to 3.16 KN at a rate of 12.7 mm/min and held under that force for 30 seconds. The compressive force was then reduced to zero at a rate of 12.0 kN/min. After 7.5 seconds of force removal, the platens were separated at the rate of 50.8 mm/min and the maximum force, in Newtons, to separate the platen was recorded. If the failure is cohesive in nature, the failed sample would be covering the surfaces of both the platens. If the cohesive strength of the sample is greater than the adhesive strength of the tape to the platens or of the tape to the sample, both the platens will not be covered with failed portion of both the samples. Samples in each of the 5 test areas were measured as above and F_{avg}, the average of five maximum force values, was calculated.

### EXAMPLES

### Comparative Example 1—High Temperature Insulative Composite Prepared Using Paste-Processible Polymer (i.e. Non-Gel Processable Polymer Matrix)

A high temperature insulative composite was prepared using a paste-processible polymer (i.e. a non-gel-processed polymer matrix) according to Example 1, Sample 3 of U.S. Patent Appl. Publ. No. 2024-0258613 A1 to Fillery et al. Briefly, fibrillatable homopolymer polytetrafluoroethylene (PTFE) fine powder particles (12 wt %), 50 wt % aerogel particles (Cabot ENOVA™ silica aerogel; Cabot Corporation, Boston, MA), 30 wt % silicon carbide particles (opacifier) (F1200 Silicon carbide, Washington Mills North Grafton, Inc., North Grafton, MA), and 8 wt % chopped glass fibers (#30 E-Glass; ¼″ cut length (6.4 mm); fiber diameter 13 microns (Fibre Glast Developments Corp., Brookville, OH) were blended with a mineral spirit lubricant. The blend was then extruded and dried to form a high temperature insulative composite in the form of a sheet as generally taught in U.S. Pat. No. 7,868,083 to Ristic-Lehmann et al. The high temperature sheet had a thickness of approximately 1.04 mm and contained the fibrillatable PTFE particles, the aerogel particles, and the silicon carbide particles durably enmeshed and immobilized within the fibrillated PTFE matrix. The non-gel-processed insulative composite demonstrated an average maximum temperature of 172° C., a Z-strength of 14.6 N, and a compressibility of 40% (Table 2).

### Example 1—High Temperature Insulative Composite

A composite comprising 9 wt % gel-processed ultra-high molecular weight polyethylene particles (UHMWPE; molecular weight of about 4,600,000 g/mol) (STAMYLAN® UH210, DSM, The Netherlands), 65 wt % fumed silica particles (AEROSIL® 200, Evonik, Germany), 25.9 wt % silicon carbide particles (opacifier) (CARBOREX® FP 1200 Silicon carbide, Washington Mills North Grafton, Inc., North Grafton, MA), and 0.05 wt % total antioxidants in equal parts (pentaerythritol tetrakis(3,5-di-tert-butyl-4-hydroxyhydrocinnamate) (IRGANOX® 1010) and tris(2,4-di-tert-butylphenyl) phosphite (IRGAFOS® 168), BASF, Germany) were blended in a mixer with mineral oil solvent (Crystal Plus Oil 500FG, STE Oil Company Inc., San Marcos, TX) to mixture ratio of 1.9:1 at room temperature (i.e., about 21° C.) to form a mixture (the components in Table 1 were blended with oil to form a mixture). The mixture was heated to a temperature of 165° C. and extruded through a die into the form of a tape using a counter-rotating twin screw extruder (BRABENDER® Twin Screw Mixer-TYPE 15-02-000, South Hackensack, NJ). Upon exiting the extruder, the tape was cooled to a temperature of about 70° C. using compressed air. The tape was then spooled onto a high-density polyethylene (HDPE) core.

The mineral oil in the cooled extruded tape was extracted from the tape while the tape was positioned on the HDPE core. The mineral oil extraction was completed by processing the tape through 3 sequential baths of low molecular weight isoparaffin (ISOPAR™ G, ExxonMobil Corp., Spring, TX). The tape remained in each bath for approximately 24 hours. After the third bath, the tape was allowed to air dry to remove any remaining isoparaffin and form a high insulative composite. The dried tape was then calendered to a final thickness.

The high temperature gel-processed insulative composite had a final thickness of approximately 1 mm and contained the gel processed polyethylene matrix (binder), fumed silica particles (insulative particles), and the silicon carbide particles (opacifier) in a cohesive composite structure. It is to be appreciated that all weight percentages were reported relative to the total weight of the final high temperature insulative composite. The gel processed insulative composite demonstrated an average maximum temperature of 178° C., a Z-strength of 488.8 N, and a compressibility of 5.1% (Table 2).

### Example 2—High Temperature Insulative Composite

A composite comprising 12 wt % gel-processed ultra-high molecular weight polyethylene particles (STAMYLAN® UH210, molecular weight of about 4,600,000 g/mol, DSM, The Netherlands), 71 wt % fumed silica particles (AEROSIL® 200, Evonik, Germany), 16 wt % silicon carbide particles (opacifier) (CARBOREX® FP1200, Washington Mills, Inc., North Grafton, MA), 1 wt % calcium stearate (Partek LUB CST, Sigma Aldrich, St. Louis, MO), and 0.05 wt % total antioxidants in equal parts (pentaerythritol tetrakis(3,5-di-tert-butyl-4-hydroxyhydrocinnamate) (IRGANOX® 1010) and tris(2,4-di-tert-butylphenyl) phosphite (IRGAFOS® 168), BASF, Germany) were blended in a mixer with mineral oil solvent (Crystal Plus Oil 500FG, STE Oil Company Inc., San Marcos, TX) at a mixture ratio of 2.2:1 at room temperature (i.e., about 21° C.) to form a mixture (the components in Table 1 were blended with oil to form a mixture). The mixture was heated to a temperature of 165° C., and gel extruded through a die into the form of a tape using a co-rotating twin screw extruder (Leistritz Extrusionstechnik GmbH, Nurnberg, Germany). Upon exiting the extruder, the tape was cooled to a temperature of about 70° C. using compressed air and spooled onto a plastic core. The tape was then calendered to the desired thickness.

After calendaring, the mineral oil in the cooled extruded tape was extracted while the tape was positioned on the plastic core. The mineral oil extraction was completed by allowing the tape to rest for 24 hours through 3 sequential baths of clean isoparaffin (ISOPAR™ G, ExxonMobil Corp., Spring, TX). After the third bath the tape was dried in an oven at a temperature of 110° C. to remove the isoparaffin and form a high temperature insulative composite.

The gel-processed high temperature insulative composite had a final thickness of approximately 1 mm and contained the gel-processed polyethylene matrix (binder), fumed silica particles (insulative particles), silicon carbide particles (opacifier), and calcium stearate and antioxidants in a cohesive composite structure. The gel-processed insulative composite demonstrated an average maximum test temperature of 160° C., a Z-strength of 817.1 N, and a compressibility of 11% (Table 2).

### Example 3—High Temperature Insulative Composite

A composite comprising 12 wt % gel-processed ultra-high molecular weight polyethylene particles (STAMYLAN® UH210, molecular weight of about 4,600,000 g/mol, DSM, The Netherlands), 71 wt % silica aerogel particles (Cabot ENOVA™ silica aerogel particles, Cabot Corp., Billerica, MA), 16 wt % silicon carbide particles (opacifier) (CARBOREX® FP1200, Washington Mills, Inc., North Grafton, MA), 1 wt % calcium stearate (Partek LUB CST, Sigma Aldrich, St. Louis MO), and 0.05 wt % total antioxidants in equal parts (pentaerythritol tetrakis(3,5-di-tert-butyl-4-hydroxyhydrocinnamate) (IRGANOX® 1010) and tris(2,4-di-tert-butylphenyl) phosphite (IRGAFOS® 168) BASF, Germany), were blended in a mixer were with isoparaffin mineral oil solvent (ISOPAR™ V, Exxon Mobil Corp., Spring, TX) to mixture ratio of 2.05:1 at room temperature (i.e., about 21° C.) to form a mixture (the components in Table 1 were blended with oil to form a mixture). The mixture was heated to a temperature of 165° C. and extruded through a die into the form of a tape using a co-rotating twin screw extruder (Leistritz Extrusionstechnik GmbH, Nurnberg, Germany). Upon exiting the extruder the tape was cooled to a temperature of about 70° C. using compressed air and spooled onto a plastic core.

The mineral oil in the cooled extruded tape was extracted while the tape was positioned on the plastic core. The mineral oil extraction was completed by allowing the tape to rest for 24 hours through 3 sequential baths of clean isoparaffin (ISOPAR™ G, ExxonMobil Corp., Spring, TX). After the third bath the tape was dried in an oven at a temperature of 110° C. to remove the isoparaffin and form a high temperature insulative composite.

The high temperature gel-processed insulative composite had a final thickness of approximately 1.1 mm and contained the gel processed polyethylene matrix (binder), silica aerogel particles (insulative particles), silicon carbide particles (opacifier), and calcium stearate and antioxidants in a cohesive composite structure. The gel processed insulative composite demonstrated an average maximum temperature of 193.0° C., a Z-strength of 499.3N, and a compressibility of 34% (Table 2).

### Example 4—High Temperature Insulative Composite Utilizing a Processing Lubricant and an Evaporative Solvent

A composite comprising 12 wt % ultra-high molecular weight polyethylene particles (STAMYLAN® UH210, molecular weight of about 4,600,000 g/mol, DSM, Netherlands), 71 wt % fumed silica particles (AEROSIL® 200, Evonik, Germany), 16 wt % silicon carbide particles (opacifier) (CARBOREX® FP1200, Washington Mills, Inc., North Grafton, MA), 1 wt % calcium stearate (Partek LUB CST, Sigma Aldrich, St. Louis, MO), and 0.05 wt % total antioxidants in equal parts (pentaerythritol tetrakis(3,5-di-tert-butyl-4-hydroxyhydrocinnamate) (IRGANOX® 1010) and tris(2,4-di-tert-butylphenyl) phosphite (IRGAFOS® 168) BASF, Germany) were blended in a mixer were with isoparaffin mineral oil solvent (ISOPAR™ M, ExxonMobil Corp., Spring, TX) to mixture ratio of 2.5:1 at room temperature (i.e., about 21° C.) to form a mixture (the components in Table 1 were blended with oil to form a mixture). The mixture was heated to a temperature of 165° C. and extruded through a die into the form of a tape using a co-rotating twin screw extruder (Leistritz Extrusionstechnik GmbH, Nurnberg, Germany). Upon exiting the extruder, the tape was cooled to a temperature of about 70° C. using compressed air and spooled onto a plastic core.

The ISOPAR™ M in the cooled extruded tape was then removed from the tape by passing it through an oven at 110° C. to remove any remaining isoparaffin and form a high temperature insulative composite.

The high temperature gel-processed insulative composite had a final thickness of approximately 1.1 mm and contained the gel processed polyethylene matrix (binder), fumed silica particles (insulative particles), silicon carbide particles (opacifier), and calcium stearate in a cohesive composite structure. The gel-processed insulative composite demonstrated an average maximum temperature of 192.5° C., a Z-strength of 546.5N, and a compressibility of 8.0% (Table 2).

### Example 5—High Temperature Insulative Composite-Utilizing a Processing Lubricant and Leaving Residual Processing Oil

A composite comprising 12 wt % gel-processed ultra-high molecular weight polyethylene particles (STAMYLAN® UH210, molecular weight of about 4,600,000 g/mol, DSM, The Netherlands), 72 wt % fumed silica particles (AEROSIL® 200, Evonik, Germany), 16 wt % silicon carbide particles (opacifier) (CARBOREX® FP1200, Washington Mills, Inc., North Grafton, MA), and 0.05 wt % total antioxidants in equal parts (pentaerythritol tetrakis(3,5-di-tert-butyl-4-hydroxyhydrocinnamate) (IRGANOX® 1010) and tris(2,4-di-tert-butylphenyl) phosphite (IRGAFOS® 168) BASF, Germany) were blended in a mixer with mineral oil solvent (Crystal Plus Oil 500FG, STE Oil Company Inc., San Marcos, TX) at a mixture ratio of 2.2:1 at room temperature (i.e., about 21° C.) to form a mixture (the components in Table 1 were blended with oil to form a mixture). The mixture was heated to a temperature of 165° C., and gel extruded through a die into the form of a tape using a co-rotating twin screw extruder (Leistritz Extrusionstechnik GmbH, Nurnberg, Germany). Upon exiting the extruder, the tape was cooled to a temperature of about 70° C. using compressed air and spooled onto a plastic core. The tape was then calendered to the desired thickness.

The mineral oil in the cooled extruded tape was extracted while the tape was positioned on the plastic core. The mineral oil extraction was completed by allowing the tape to rest for 24 hours through 2 sequential baths of clean isoparaffin (ISOPAR™ G, ExxonMobil Corp., Spring, TX). After the third bath the tape was dried in an oven at a temperature of 110° C. to remove the isoparaffin and form a high temperature insulative composite.

The high temperature gel processed insulative composite had a final thickness of approximately 1 mm and contained the gel processed polyethylene matrix (binder), fumed silica particles (insulative particles), silicon carbide particles (opacifier) in a cohesive composite structure. The amount of residual processing oil in the tape was 25 wt %. The gel processed insulative composite demonstrated an average maximum temperature of 218° C., a z-strength of 708.3N, and a compressibility of 18% (Table 2).

### Example 6—High Temperature Insulative Composite-Utilizing a Processing Lubricant, an Evaporative Solvent, and a Flame Retardant (FR) Additive

A composite comprising 12 wt % gel-processed ultra-high molecular weight polyethylene particles (STAMYLAN® UH210, molecular weight of about 4,600,000 g/mol, DSM, Netherlands), 69 wt % fumed silica particles (AEROSIL® 200, Evonik, Germany), 15 wt % silicon carbide particles (opacifier) (CARBOREX® FP1200, Washington Mills, Inc., North Grafton, MA), 3 wt % flame retardant (FR Additive) (Melapur 200, BASF, Florham Park, NJ), 1 wt % calcium stearate (Partek LUB CST, Sigma Aldrich, St. Louis MO), and 0.05 wt % total antioxidants in equal parts (pentaerythritol tetrakis(3,5-di-tert-butyl-4-hydroxyhydrocinnamate) (IRGANOX® 1010) and tris(2,4-di-tert-butylphenyl) phosphite (IRGAFOS® 168) BASF, Germany) were blended in a mixer with mineral oil solvent (Crystal Plus Oil 500FG, STE Oil Company Inc., San Marcos, TX) at a mixture ratio of 2.45:1 at room temperature (i.e., about 21° C.) to form a mixture (the components in Table 1 were blended with oil to form a mixture). The mixture was heated to a temperature of 165° C., and gel extruded through a die into the form of a tape using a co-rotating twin screw extruder (Leistritz Extrusionstechnik GmbH, Nurnberg, Germany). Upon exiting the extruder, the tape was cooled to a temperature of about 70° C. using compressed air and spooled onto a plastic core.

The ISOPAR™ M in the cooled extruded tape was then removed from the tape by passing it through an oven at 110° C. to remove any remaining isoparaffin and form a high temperature insulative composite.

The high temperature gel processed insulative composite had a final thickness of approximately 1.0 mm and contained the gel processed polyethylene matrix (binder), fumed silica particles (insulative particles), silicon carbide particles (opacifier), FR Additive, and Calcium Stearate in a cohesive composite structure. The gel processed insulative composite demonstrated an average maximum temperature of 185° C., a z-strength of 338.1N, and a compressibility of 12% (Table 2).

### Example 7 (PROPHETIC)—High Temperature Insulative Composite-Utilizing a Processing Lubricant, an Evaporative Solvent, and a Blend of Different Silica Types

A composite comprising 12 wt % gel-processed ultra-high molecular weight polyethylene particles (STAMYLAN® UH210, molecular weight of about 4,600,000 g/mol, DSM, Netherlands), 56.8 wt % fumed silica particles (AEROSIL® 200, Evonik, Germany), 14.2 wt % precipitated silica particles (SIPERNAT® 22 S, Evonik, Germany), 16 wt % silicon carbide particles (opacifier) (CARBOREX® FP1200 Silicon carbide, Washington Mills North Grafton, Inc., North Grafton, MA), and <0.1 wt % antioxidant (IRGANOX® 1010, BASF, Germany), and 1 wt % calcium stearate as a processing lubricant (Partek LUB CST, Sigma Aldrich, St. Louis MO and source) are blended in a mixer with parrafinic mineral oil solvent (ISOPAR™ M, ExxonMobil Corp., Spring, TX) to mixture ratio of 2.5:1 at room temperature (i.e., about 21° C.) to form a mixture. The mixture is heated to a temperature of 165° C., and is extruded through a die into the form of a tape using a counter rotating twin screw extruder (BRABENDER® Twin Screw Mixer-TYPE 15-02-000, South Hackensack, NJ). Upon exiting the extruder the tape is cooled to a temperature of about 70° C. using compressed air. The tape is then spooled onto a polyvinyl chloride (PVC) core.

The ISOPAR™ M in the cooled extruded tape is then removed from the tape by passing it through an oven at 110° C. to remove any remaining isoparaffin and form a high temperature insulative composite.

The high temperature gel processed insulative composite is then calendared to a final thickness of approximately 1.2 mm. The high temperature gel processed insulative composite contains the gel processed polyethylene matrix (binder), fumed and precipitated silica particles (insulative particles), silicon carbide particles (opacifier), and residual calcium stearate in a cohesive composite structure.

It is to be appreciated that all weight percentages were reported relative to the total weight of the final high temperature insulative composite. The gel processed insulative composite is then tested to determine the average maximum temperature, a z-strength, and compressibility.

### Example 8 (PROPHETIC)—High Temperature Insulative Composite

Using a process same as described in Example 4, a composite was formed with the composition as shown in Table 1.

The high temperature gel-processed insulative composite had a final thickness of approximately 1.1 mm and contained the gel processed polyethylene matrix (binder), fumed silica particles (insulative particles), silicon carbide particles (opacifier), and calcium stearate in a cohesive composite structure.

### Example 9 (PROPHETIC)—High Temperature Insulative Composite

Using a process same as described in Example 4, a composite was formed with the composition as shown in Table 1.

The high temperature gel-processed insulative composite had a final thickness of approximately 1.1 mm and contained the gel processed polyethylene matrix (binder), fumed silica particles (insulative particles), silicon carbide particles (opacifier), and calcium stearate in a cohesive composite structure.

### Example 10 (PROPHETIC)—High Temperature Insulative Composite

Using a process same as described in Example 4, a composite was formed with the composition as shown in Table 1.

The high temperature gel-processed insulative composite had a final thickness of approximately 1.1 mm and contained the gel processed polyethylene matrix (binder), fumed silica particles (insulative particles), silicon carbide particles (opacifier), and calcium stearate in a cohesive composite structure.

TABLE 1
Weight Percent of Components in High Temperature Insulative Compositions

| Material | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| Fumed silica | 64.95% | 70.95% | | 70.95% | 71.95% | 68.95% | 56.80% | 71.95% | 59.98% | 52.98% |
| Silica aerogel | | | 70.95% | | | | | | | |
| Precipitated silica | | | | | | | 14.20% | | | |
| Silicon Carbide | 26.00% | 16.00% | 16.00% | 16.00% | 16.00% | 15.00% | 16.00% | 8.03% | 22.00% | 37.00% |
| UHMWPE | 9.00% | 12.00% | 12.00% | 12.00% | 12.00% | 12.00% | 12.00% | 19.00% | 17.00% | 9.00% |
| FR additive | | | | | | 3.00% | | | | |
| Calcium stearate | | 1.00% | 1.00% | 1.00% | | 1.00% | 1.00% | 1.00% | 1.00% | 1.00% |
| IRGAFOS ® 168 | 0.025% | 0.025% | 0.025% | 0.025% | 0.025% | 0.025% | | 0.010% | 0.010% | 0.010% |
| IRGANOX ® 1010 | 0.025% | 0.025% | 0.025% | 0.025% | 0.025% | 0.025% | | 0.010% | 0.010% | 0.010% |

TABLE 2
Properties of High Temperature Insulative Compositions

| | Maximum Test | | |
|---|---|---|---|
| | Temperature | Z-Strength | Compressibility |
| Example | (° C.) | (N) | at 1 MPa (%) |
| 1 | 178 | 488.8 | 5.1 |
| 2 | 160 | 817.1 | 11 |
| 3 | 193 | 499.3 | 34 |
| 4 | 193 | 546.5 | 8.0 |
| 5 | 218 | 708.3 | 18 |
| 6 | 185 | 338.1 | 12 |
| Comparative | 172 | 14.6 | 40 |
| Example 1 | | | |

### Example 11—Ultrasonic Bonded Multilayer Insulative Composite

The tape from Example 4, upon exiting the extruder and before being cooled to a temperature of about 70° C., was calendered to 1 mm thick. The Isopar™ M in the cooled extruded tape was then removed from the tape by passing it through an oven at 115° C. to remove any remaining isoparaffin and form a high temperature insulative composite.

The high temperature gel-processed insulative composite had a final thickness of approximately 1.0 mm and contained the gel processed polyethylene matrix (binder), fumed silica particles (insulative particles), silicon carbide particles (opacifier), and calcium stearate in a cohesive composite structure. The gel-processed insulative composite demonstrated a compressibility as shown in Table 3.

Two layers of the 1.0 mm thick insulative composite were stacked and then bonded using an ultrasonic sealer (Branson Model FS-90 with Branson 2000BDC Power Supply), and were successfully bonded by ultrasonic bonding to make a multilayer insulative composite with a total thickness as shown in Table 3.

The power was 100% and the pressure was 20 psi. The anvil with dot pattern was used to create two dotted lines in the machine direction, corresponding to a bonded area of approximately 1%.

### Example 12—Ultrasonic Bonded Multilayer Insulative Composite

The tape from Example 4, upon exiting the extruder and before being cooled to a temperature of about 70° C., was calendered to 0.5 mm thick. The Isopar™ M in the cooled extruded tape was then removed from the tape by passing it through an oven at 115° C. to remove any remaining isoparaffin and form a high temperature insulative composite.

The high temperature gel-processed insulative composite had a final thickness of approximately 0.5 mm and contained the gel processed polyethylene matrix (binder), fumed silica particles (insulative particles), silicon carbide particles (opacifier), and calcium stearate in a cohesive composite structure. The gel-processed insulative composite demonstrated a compressibility as shown in Table 3.

Two layers of the 0.5 mm thick insulative composite were stacked and then bonded using an ultrasonic sealer (Branson Model FS-90 with Branson 2000BDC Power Supply), and were successfully bonded by ultrasonic bonding to make a multilayer insulative composite with a total thickness and maximum test temperature as shown in Table 3.

The power was 100% and the pressure was 50 psi. The anvil with radiused edge was used to create an edge bond, in which the pressure was high enough to cut through the two layers while the material was bonded. The result is a seam that defines the edge of the layered composite, and material outside of that bonded seam is discarded. The outer perimeter has a bonded length of 100%.

### Example 13—Ultrasonic Bonded Multilayer Insulative Composite

Two layers of the 0.5 mm thick insulative composite from Example 11 were stacked and then bonded using an ultrasonic sealer (Branson Model FS-90 with Branson 2000BDC Power Supply), and were successfully bonded by ultrasonic bonding to make a multilayer insulative composite with a total thickness and maximum test temperature as shown in Table 3.

The power was 100% and the pressure was 30 psi. The anvil with flat edge was used to create two straight lines in the transverse direction, corresponding to a bonded area of approximately 2%.

### Comparative Example 2—Multilayer Insulative Composite with Adhesive Bond

Two layers of the 0.5 mm thick insulative composite from Example 11 were stacked and then bonded with a 30 μm thick acrylic adhesive (HPA 1901 from Avery Dennison) in between the two layers. A roller was used to laminate the layers together at room temperature to make a multilayer insulative composite with total thickness and maximum test temperature as shown in Table 3.

As shown in Table 3, the multilayer insulative composite bonded with adhesive (Comparative Example 2) has a higher maximum test temperature than the multilayer insulative composites bonded with ultrasonic bonding (Example 11, Example 12).

### Example 14—Ultrasonic Bonded Multilayer Insulative Composite

The tape from Example 4, upon exiting the extruder and before being cooled to a temperature of about 70° C., was calendered to 0.5 mm thick. The Isopar™ M in the cooled extruded tape was then removed from the tape by passing it through an oven at 115° C. to remove any remaining isoparaffin and form a high temperature insulative composite.

The high temperature gel-processed insulative composite had a final thickness of approximately 0.5 mm and contained the gel processed polyethylene matrix (binder), fumed silica particles (insulative particles), silicon carbide particles (opacifier), and calcium stearate in a cohesive composite structure. The gel-processed insulative composite demonstrated a compressibility as shown in Table 3.

Four layers of the 0.5 mm thick insulative composite were stacked and then bonded using an ultrasonic sealer (Branson Model FS-90 with Branson 2000BDC Power Supply), and were successfully bonded by ultrasonic bonding to make a multilayer insulative composite with a total thickness as shown in Table 3.

The power was 100% and the pressure was 50 psi. The anvil with dashed pattern was used to create one discontinuous line in the machine direction, corresponding to a bonded area of approximately 0.5%.

### Example 15—Ultrasonic Bonded Multilayer Insulative Composite

The tape from Example 4, upon exiting the extruder and before being cooled to a temperature of about 70° C., was calendered to 0.2 mm thick. The Isopar™ M in the cooled extruded tape was then removed from the tape by passing it through an oven at 115° C. to remove any remaining isoparaffin and form a high temperature insulative composite.

The high temperature gel-processed insulative composite had a final thickness of approximately 0.2 mm and contained the gel processed polyethylene matrix (binder), fumed silica particles (insulative particles), silicon carbide particles (opacifier), and calcium stearate in a cohesive composite structure. The gel-processed insulative composite demonstrated a compressibility as shown in Table 3.

Ten layers of the 0.2 mm thick insulative composite were stacked and then bonded using an ultrasonic sealer (Branson Model FS-90 with Branson 2000BDC Power Supply), and were successfully bonded by ultrasonic bonding to make a multilayer insulative composite with a total thickness as shown in Table 3.

The power was 100% and the pressure was 30 psi. The anvil with dot pattern was used to create one dotted line in the machine direction, corresponding to a bonded area of approximately 0.5%.

TABLE 3
Properties of Multilayer Insulative Composites

| | Thick- | Compress- | | | |
|---|---|---|---|---|---|
| | ness of | ibility of | | | Maximum |
| | insulative | insulative | # | Total | test tem- |
| | composite | composite | Layers | thickness | perature |
| Example | (mm) | (%) | bonded | (mm) | (° C.) |
| 11 | 1.0 | 2.5 | 2 | 2.0 | N/A |
| 12 | 0.5 | 3.8 | 2 | 1.0 | 178 |
| 13 | 0.5 | 3.8 | 2 | 1.0 | 180 |
| 14 | 0.5 | 3.8 | 4 | 2.0 | N/A |
| 15 | 0.2 | 6.0 | 10 | 2.0 | N/A |
| Comparative | 0.5 | 3.8 | 2 | 1.0 | 185 |
| Ex 2 | | | | | |

### Example 16—Ultrasonic Bonded Multilayer Insulative Composite with Compressible Foam

The tape from Example 4, upon exiting the extruder and before being cooled to a temperature of about 70° C., was calendered to 0.5 mm thick. The Isopar™ M in the cooled extruded tape was then removed from the tape by passing it through an oven at 115° C. to remove any remaining isoparaffin and form a high temperature insulative composite.

The high temperature gel-processed insulative composite had a final thickness of approximately 0.5 mm and contained the gel processed polyethylene matrix (binder), fumed silica particles (insulative particles), silicon carbide particles (opacifier), and calcium stearate in a cohesive composite structure.

One layer of the 0.5 mm thick insulative composite was stacked with one layer of 1.0 mm thick polyurethane foam (Poron EV Extend 4701-43RL-10039-04 from Rogers Corporation) and then bonded using an ultrasonic sealer (Branson Model FS-90 with Branson 2000BDC Power Supply), and were successfully bonded by ultrasonic bonding to make a multilayer insulative composite with a total thickness of 1.5 mm.

The power was 100% and the pressure was 30 psi. The anvil with radiused edge was used to create an edge bond, in which the pressure was high enough to cut through the two layers while the material was bonded. The result is a seam that defines the edge of the layered composite, and material outside of that bonded seam is discarded. The outer perimeter has a bonded length of 50%.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A multilayer insulative composite comprising:
an insulative composite layer comprising greater than about 50 wt % of insulative particles, less than about 35 wt % of a gel processed polymer matrix, and less than about 35 wt % of a combined total of additional components, based on the total weight of the insulative composite layer; and
a second layer bonded to the insulative composite layer to define a diffused bonded portion of the multilayer insulative composite;
wherein the diffused bonded portion is defined by an ultrasonic bond;
wherein the insulative composite layer has a compressibility less than about 35% at 1 MPa, optionally wherein the second layer includes a second insulative composite layer comprising greater than about 50 wt % of insulative particles, less than about 35 wt % of a gel processed polymer matrix, and less than about 35 wt % of a combined total of additional components based on the total weight of the second insulative composite layer.

2. The multilayer insulative composite of claim 1, wherein the second layer includes a compressible foam layer or a porous layer, optionally wherein the compressible foam layer comprises a polyurethane foam.

3. The multilayer insulative composite of claim 1, wherein the diffused bonded portion includes an edge bond along an outer perimeter of the insulative composite layer, optionally wherein the edge bond includes one or more edge bond portions adjacent to the outer perimeter, on the outer perimeter, or both adjacent to and on the outer perimeter of the insulative composite layer.

4. The multilayer insulative composite of claim 3, wherein the edge bond is
(a) defined along the outer perimeter and spans from 10% to 100% of a total length of the outer perimeter of the insulative composite layer;
(b) defined by a plurality of discontinuous edge bond portions along the outer perimeter; or
(c) defined by a continuous bond along the outer perimeter.

5. The multilayer insulative composite of claim 1, wherein the diffused bonded portion includes one or more interior bond portions defined within the outer perimeter of the multilayer insulative composite between opposing faces of the insulative composite layer and the second layer, optionally wherein the interior bond portions are defined over from 0.1% to 20% of a surface area of the opposing faces of the insulative composite layer and the second layer.

6. The multilayer insulative composite of claim 5, wherein the interior bond portions are arranged in a pattern across the opposing faces of the insulative composite layer and the second layer, optionally wherein the pattern includes either a regular, repeating pattern or a random pattern, and optionally wherein the interior bond portions are characterized by a shape, and further wherein the shape includes a square, rounded, rectangular, linear, irregular, or polygonal shape.

7. The multilayer insulative composite of claim 1, characterized by an absence of any adhesive between the insulative composite layer and the second layer, optionally wherein the insulative composite layer has a thickness of from about 0.1 mm to about 2 mm, and optionally wherein the insulative composite layer defines a geometric shape comprising a rectangle, a circle, a triangle, a square, an oval, or a polygon.

8. The multilayer insulative composite of claim 7, wherein the multilayer insulative composite comprises more than two insulative composite layers, optionally wherein the multilayer insulative composite includes from 3 to 10 insulative composite layers bonded to each adjacent layer using ultrasonic bonding, and optionally wherein the multilayer insulative composite has a total thickness of from about 0.2 mm to about 20 mm.

9. An article comprising the multilayer insulative composite of claim 1.

10. The multilayer insulative composite of claim 1, wherein the insulative particles are selected from fumed silica, amorphous silica, colloidal silica, precipitated silica, fused silica, silica gel, silica xerogel, aerogels, silica aerogels, silicates, fumed metal oxides, and combinations thereof, optionally wherein the insulative particles comprise greater than about 70 wt % of the insulative composite.

11. The multilayer insulative composite of claim 1, wherein the gel processed polymer matrix comprises a gel processed polymer selected from polyethylene, polypropylene, ethylene-propylene copolymers, polyoxymethylene, polyethylene oxide, polyamides, polyethyleneterephtalate, polyacrylonitrile, polyvinylalcohol, polyhydroxyalkanoates (PHAs), polylactic acid (PLA), and polyvinylidenefluoride, optionally wherein the gel processed polymer matrix comprises a gel processed polyethylene (PE) having a number average molecular weight greater than about 500,000 g/mol, and optionally wherein the gel processed polymer matrix comprises a blend of at least two different number average molecular weights of the gel processed polymer.

12. The multilayer insulative composite of claim 1, wherein the gel processed polymer matrix comprise less than about 20 wt % of the insulative composite, optionally wherein the insulative composite is non-particulating, and optionally wherein the insulative composite is in the form of an extruded profile, extruded article, injection molded shape, or injection molded article.

13. The multilayer insulative composite of claim 1, wherein a total of the additional components comprises one or more opacifier, one or more antioxidant, one or more reinforcement fiber, or any combination thereof, optionally wherein the opacifier is selected from carbon black, titanium dioxide, aluminum oxide, zirconium dioxide, iron oxides, silicon carbide, molybdenum silicide, manganese oxide, a polydialkylsiloxane where the alkyl groups contain 1 to 7 carbon atoms, or any combination thereof, and optionally wherein a total of the additional components comprises less than about 20 wt % of the insulative composite.

14. The multilayer insulative composite of claim 1, wherein the insulative particles and additional components are present through a thickness thereof, optionally wherein particulate components are present through a thickness thereof.

15. An article comprising:
a first component capable of a generating a high temperature event comprising a first temperature;
a second component to be protected against exposure to the first temperature; and
a multilayer insulative composite positioned between the first component and the second component, the multilayer insulative composite having a first side oriented toward the first component and an opposing side oriented towards the second component;
wherein the multilayer insulative composite comprises:
an insulative composite layer comprising greater than about 50 wt % of insulative particles, less than about 35 wt % of a gel processed polymer matrix, and less than about 35 wt % of a combined total of additional components, based on the total weight of the insulative composite layer; and
a second layer bonded to the insulative composite layer to define a diffused bonded portion of the multilayer insulative composite;
wherein the diffused bonded portion is defined by an ultrasonic bond;
wherein the insulative composite layer has a compressibility less than about 35% at 1 MPa,
optionally wherein the second layer includes a compressible foam layer or a porous layer.

16. The article of claim 15, wherein the gel processed polymer matrix comprises a gel processed polymer selected from polyethylene, polypropylene, ethylene-propylene copolymers, polyoxymethylene, polyethylene oxide, polyamides,
polyethyleneterephtalate, polyacrylonitrile, polyvinylalcohol, polyhydroxyalkanoates (PHAs), polylactic acid (PLA), and polyvinylidenefluoride, optionally wherein the gel processed polymer matrix comprises less than about 20 wt % of the insulative composite, optionally wherein the gel processed polymer matrix comprises an expanded gel processed polyethylene (PE) having a number average molecular weight greater than 500,000 g/mol, optionally wherein the gel processed polymer matrix comprises a blend of at least two different number average molecular weights of the gel processed polymer.

17. The article of claim 15, wherein the insulative particles are selected from fumed silica, amorphous silica, colloidal silica, precipitated silica, fused silica, silica gel, silica xerogel, aerogels, silica aerogels, silicates, fumed metal oxides, and combinations thereof, optionally wherein the insulative particles comprise greater than about 70 wt % of the insulative composite.

18. The article of claim 15, wherein the additional components comprise one or more opacifier, one or more antioxidant, one or more reinforcement fiber or any combination thereof, optionally wherein a total of the additional components comprises less than about 20 wt % of the insulative composite, optionally wherein the article has a thickness less than about 25 mm, and optionally wherein the article prevents thermal propagation in a lithium-ion battery, and optionally comprising a support layer directly bonded to the insulative composite.

19. A method of using the article of claim 15 to prevent thermal propagation within a lithium-ion battery.

20. A method of forming the multilayer insulative composite according to claim 1 comprising:
providing an insulative composite layers comprising greater than about 50 wt % of insulative particles, less than about 35 wt % of a gel processed polymer matrix, and less than about 35 wt % of a combined total of additional components, based on the total weight of the insulative composite layer;
providing a second layer comprising a second insulative composite layer or a compressible foam layer; and
applying ultrasonic energy to an edge or a surface of the insulative composite layer and the second layer to bond the insulative composite layer to the second layer;
wherein the insulative composite layer has a compressibility less than about 35% at 1 MPa.

21. A lithium-ion battery comprising:
a first battery cell capable of a generating a high temperature event comprising a first temperature;
a second battery cell to be protected against exposure to the first temperature; and
a multilayer insulative composite positioned between the first battery cell and the second battery cell, the multilayer insulative composite having a first side oriented toward the first battery cell and an opposing side oriented towards the battery cell;
wherein the multilayer insulative composite comprises:
an insulative composite layer comprising greater than about 50 wt % of insulative particles, less than about 35 wt % of a gel processed polymer matrix, and less than about 35 wt % of a combined total of additional components, based on the total weight of the insulative composite layer; and
a second layer bonded to the insulative composite layer to define a diffused bonded portion of the multilayer insulative composite; wherein the diffused bonded portion is defined by an ultrasonic bond;
wherein the insulative composite layer has a compressibility less than about 35% at 1 MPa.

22. The multilayer insulative composite of claim 1, wherein the insulative composite layer has an average maximum temperature less than about 250° C. as determined using a protective heat propagation barrier assay at about 1 mm thickness, optionally wherein the insulative composite layer has a Z-strength greater than about 25 N.

23. The multilayer insulative composite of claim 1, wherein the diffused bonded portion comprises an interdiffused bonded portion, optionally wherein the diffused bonded portion has a higher density than a density of the insulative composite layer; wherein the diffused bonded portion has a higher density than a density of the second layer.
